(19) United States
(12) Patent Application Publication
(10) Pub. No.: US 2026/0227236 A1
(43) Pub. Date: Aug. 6, 2026

(54) SELF-HEALING PHOTOCHROMIC ELASTOMER COMPOSITIONS FOR WEARABLE ULTRAVIOLET-SENSORS

(71) Applicant: The Regents of The University of Michigan, Ann Arbor, MI (US)

(72) Inventors: Daniel CRESPY, Rayong (TH); Twa YIMYAI, Rayong (TH); Abdon PENA-FRANCESCH, Ann Arbor, MI (US)

(73) Assignee: The Regents of The University of Michigan, Ann Arbor, MI (US)

(21) Appl. No.: 19/157,244

(22) PCT Filed: Feb. 15, 2024
(86) PCT No.: PCT/US2024/015973

§ 371 Date: Aug. 15, 2025

Related U.S. Application Data
(60) Provisional application No. 63/446,051, filed on Feb. 16, 2023.

(51) Int. Cl. G01J 1/50; C09K 9/02; G01J 1/02

(52) U.S. Cl. CPC G01J 1/50; C09K 9/02; G01J 1/0238; C09K 2211/1033; C09K 2211/1441; G01J 2001/0257

(57) ABSTRACT

Compositions for detecting ultraviolet (UV) radiation are provided that include a self-healing elastomeric polymer (e.g., functionalized polyurethane) having an electron donor functional group (e.g., dynamic disulfide bonds) and a photochromic component distributed in the elastomeric polymer. The composition is configured to display a color change when exposed to ultraviolet radiation. Products and methods for detecting ultraviolet (UV) radiation with such compositions are also provided. The products may include wearable devices, such as wristbands, stickers, patches, and the like.

### CROSS-REFERENCE TO RELATED APPLICATIONS

This application claims the benefit of U.S. Provisional Application No. 63/446,051, filed on Feb. 16, 2023. The entire disclosure of the above application is incorporated herein by reference.

### FIELD

The present disclosure relates to products, compositions, and methods for detecting ultraviolet (UV) radiation with a composition that includes a self-healing elastomeric polymer and a photochromic component distributed therein capable of exhibiting a color change after exposure to UV radiation.

### BACKGROUND

This section provides background information related to the present disclosure which is not necessarily prior art.

Ultraviolet (UV) light, having wavelengths of about 100 nm to about 400 nm, is a type of electromagnetic radiation that can be generated naturally or synthetically and can be either potentially beneficial or harmful. Synthetic UV light is abundantly utilized in the healthcare industry (in the disinfection of medical surfaces and devices, or in the production of vitamin D, and in phototherapy and photoimaging) as well as in industrial manufacturing processes such as 3D printing/additive manufacturing, photocuring of polymers, laser micromachining, and the like. However, overexposure to UV light can be harmful to human health, including causing potential damage to eyes and skin, as well as suppressing the immune system. In particular, the UV light penetrating into the skin can be absorbed by cellular chromophores (e.g., hemoglobin, melanin, DNA, and nucleic acids), resulting in the production of free radicals or reactive oxygen species. The generated reactive species cause oxidation of biological macromolecules (proteins, lipids, and nucleic acids) and cellular components in skin, which leads to skin inflammation, skin aging, and ultimately skin cancer. It was estimated that more than 419,000 cases of UV-induced skin cancer (basal cell carcinomas, squamous cell carcinomas, or melanomas) occur each year in the United States, with an annual cost of direct medical care of approximately 343 million dollars. Therefore, monitoring of UV light exposure is essential to ensure safe protection and to avoid UV-derived health problems. Most commercial UV-sensors are mainly in the form of electronic solid-state devices, which are typically rigid and fragile, which limit their portability and their application in the field due to a lack of compliance and resiliency.

In recent years, wearable UV-sensors have been developed to monitor exposure for healthcare applications, with major advantages in portability enabling easy point-of-care testing and real-time monitoring in the field. However, such UV sensors may be bulky in addition to being rigid, fragile, and having limited application in wearable technology. It would be desirable to provide compact, accurate, robust, self-healing UV-detector or sensors, especially those that can be incorporated into wearable devices.

### SUMMARY

This section provides a general summary of the disclosure and is not a comprehensive disclosure of its full scope or all of its features.

In certain aspects the present disclosure relates to a composition for detecting ultraviolet (UV) radiation. The composition optionally comprises a self-healing elastomeric polymer comprising an electron donor functional group. The composition also comprises a photochromic component distributed in the self-healing elastomeric polymer. The photochromic component is configured to display a color change when exposed to ultraviolet radiation. The electron donor functional group promotes a photochromic reaction of the photochromic component in the presence of the ultraviolet radiation.

In one aspect, the self-healing elastomeric polymer comprises a polyurethane and the electron donor functional group comprises a disulfide group.

In one aspect, the photochromic component is selected from the group consisting of: phosphomolybdic acid, spiropyrans, such as 1,3,3-trimethylindolino-6′-nitrobenzopyrylospiran (SP), and combinations thereof.

In one aspect, the composition is substantially free of any added dopants or catalysts.

In one aspect, the photochromic component is present at greater than or equal to about 0.1 % by weight to less than or equal to about 40% by weight of the composition.

In one aspect, the self-healing elastomeric polymer is present at greater than or equal to about 60 % by weight to less than or equal to about 99.9% by weight of the composition.

In one aspect, the self-healing elastomeric polymer comprises a polyurethane and the electron donor functional group comprises a disulfide group. Further, the photochromic component comprises phosphomolybdic acid, so that the photochromic reaction promotes reduction of molybdenum in the phosphomolybdic acid in the presence of the ultraviolet radiation.

In one aspect, the photochromic component is homogenously distributed in the self-healing elastomeric polymer and defines a composite material.

In one aspect, the color change is reversible so that the composition can be regenerated and reused to detect exposure to ultraviolet radiation at least two times.

In one aspect, the ultraviolet radiation is selected from the group consisting of: UVA, UVB, UVC, and combinations thereof. Further, the color change may reflect a cumulative exposure to ultraviolet radiation. Also, the at least one detection region has a sensitivity to ultraviolet radiation at an intensity of greater than or equal to about 2 mW/cm² to less than or equal to about 5.6mW/cm².

In certain aspects, the present disclosure relates to a product for detecting ultraviolet (UV) radiation. The product optionally comprises at least one detection region configured to receive and display a color change after exposure to ultraviolet (UV) radiation. The detection region has a composite material comprising a self-healing elastomeric polymer matrix comprising an electron donor functional group and a photochromic component distributed in the polymer matrix. The electron donor functional group promotes a photochromic reaction of the photochromic component in the presence of the ultraviolet radiation.

In one aspect, the product further comprises at least one reference region in proximity with the at least one detection region. The at least one reference region also comprises the self-healing elastomeric polymer matrix comprising the electron donor functional group and the photochromic component. The at least one reference region has a first color indicating exposure to a predetermined amount of ultraviolet radiation that can be compared to a second color of the at least one detection region for determining an exposure level of the at least one detection region to ultraviolet radiation.

In one aspect, the at least one reference region comprises at least two reference regions, wherein a first reference region has a first amount of the photochromic component, a second reference region has a second amount of the photochromic component, wherein the first amount is greater than the second amount.

In one aspect, the at least one detection region is a layer disposed in or on a layer of the self-healing elastomeric polymer matrix comprising an electron donor functional group where the photochromic component is absent.

In one aspect, the at least one detection region is a layer disposed over a layer of adhesive.

In one further aspect, the product comprises a first layer with the at least one detection region and an intermediate layer comprising a first side adjacent to the first layer. The intermediate layer comprises the self-healing elastomeric polymer matrix comprising an electron donor functional group where the photochromic component is absent. The product further comprises a third layer adjacent to a second side of the intermediate layer comprising the adhesive.

In one aspect, the product further comprises at least one layer of an ultraviolet radiation filter disposed over the at least one detection region.

In one aspect, the product is wearable by a user and the at least one detection region is visible and configured to display the color change to the user.

In one aspect, the product is selected from the group consisting of: a sticker, a wristband, a patch, and combinations thereof.

In one aspect, the product is waterproof, free of any batteries, and the color change is reversible. Thus, the product can be reused when the at least one detection region is regenerated and capable of detecting exposure to ultraviolet radiation at least two times.

In one aspect, the self-healing elastomeric polymer matrix comprises a polyurethane, the electron donor functional group comprises a disulfide group, and the photochromic component comprises phosphomolybdic acid. The photochromic reaction promotes reduction of molybdenum in the phosphomolybdic acid in the presence of the ultraviolet radiation.

In one aspect, the ultraviolet radiation is selected from the group consisting of: UVA, UVB, UVC, and combinations thereof. The color change reflects cumulative exposure to ultraviolet radiation, and the at least one detection region has a sensitivity to ultraviolet radiation at an intensity of greater than or equal to about 2 mW/cm² to less than or equal to about 5.6 mW/cm².

In further aspects, the present disclosure relates to a method for detecting ultraviolet (UV) radiation. The method optionally comprises disposing a product having at least one detection region in an environment where UV radiation may be present. The detection region comprises a composite material comprising a self-healing elastomeric polymer matrix comprising an electron donor functional group and a photochromic component distributed in the polymer matrix. The electron donor functional group promotes a photochromic reaction of the photochromic component in the presence of the ultraviolet radiation. The method may further comprise detecting exposure to UV radiation after the at least one detection region of the product displays a color change.

In one aspect, the product further comprises at least one reference region in proximity with the at least one detection region. The at least one reference region also comprises the composite material comprising the self-healing elastomeric polymer matrix comprising the electron donor functional group and the photochromic component. The at least one reference region has a first color indicating exposure to a predetermined amount of ultraviolet radiation and the detecting further comprises comparing the first color to a second color reflecting the color change of the at least one detection region for determining an exposure level of the at least one detection region to ultraviolet radiation.

In one aspect, the product is selected from the group consisting of: a sticker, a wristband, a patch, and combinations thereof.

In one aspect, after the detecting, the method further comprises regenerating the product by subjecting the product to a regeneration cycle by exposing the product to at least one of heat, energy, or exposure to an oxidant, so that the product can be reused when the at least one detection region is regenerated and is capable of detecting exposure to UV radiation again.

In one further aspect, the photochromic component comprises phosphomolybdic acid (PMA) and the regenerating comprises exposing the product to an oxidant comprising hydrogen peroxide (H₂O₂).

In one further aspect, the photochromic component comprises 1,3,3-trimethylindolino-6′-nitrobenzopyrylospiran (SP) and the regenerating comprises exposing the product to a temperature of greater than or equal to about 60° C.

In one aspect, the method further comprises healing any mechanical damage to the product by subjecting the product to a self-healing cycle by exposing the product to at least one of heat or energy.

In one aspect, the self-healing elastomeric polymer matrix comprises a polyurethane, the electron donor functional group comprises a disulfide group, and the photochromic component comprises phosphomolybdic acid, wherein photochromic reaction promotes reduction of molybdenum in the phosphomolybdic acid in the presence of the ultraviolet radiation.

In one aspect, the ultraviolet radiation is selected from the group consisting of: UVA, UVB, UVC, and combinations thereof, the color change reflects cumulative exposure to ultraviolet radiation, and the at least one detection region has a sensitivity to ultraviolet radiation at an intensity of greater than or equal to about 2 mW/cm² to less than or equal to about 5.6 mW/cm².

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIGS. 1A-1B. FIG. 1A shows a reaction mechanism for forming a functionalized self-healing polyurethane elastomer having an electron donating functional group incorporated therein prepared in accordance with certain aspects of the present disclosure. FIG. 1B shows a reaction mechanism for forming a comparative polyurethane lacking an electron donating functional group without self-healing ability.

FIGS. 2A-2D. FIG. 2A shows a photochromic mechanism between phosphomolybdic acid hydrate (PMA) and urethane groups in a self-healing polyurethane (PUSH) polymer network prepared in accordance with certain aspects of the present disclosure. FIG. 2B shows a photochromic component (PMA) deposited on a PUSH polymer film, showing color change after exposure to UVA light. FIG. 2C shows photochromic elastomer composites (photoPUSH) with a color change after exposure to UV light. FIG. 2D shows the photoPUSH composite prepared in accordance with certain aspects of the present disclosure is capable of self-healing after damage upon activation with temperature, and still displays color change upon UV light exposure.

FIGS. 3A-3E. FIG. 3A shows absorbance at 760 nm as a function of UVA, B, and C light doses in photoPUSH films prepared in accordance with certain aspects of the present disclosure having a photochromic component (PMA) at 5.7 wt. %. FIG. 3B shows UV-visible absorbance spectra of a photoPUSH prepared in accordance with certain aspects of the present disclosure (5.7 wt. % PMA) with increasing exposure to UVA light. FIG. 3C shows a color change of photoPUSH prepared in accordance with certain aspects of the present disclosure with different amount of photochromic agent (PMA) with increasing doses of UVA light. FIG. 3D shows absorbance at 760 nm as a function of UVA light dose for a photoPUSH film (5.7 wt. % PMA) prepared in accordance with certain aspects of the present disclosure. FIG. 3E shows normalized absorbance at 760 nm as a function of UVA light dose for photoPUSH (5.7 wt. % PMA) films prepared in accordance with certain aspects of the present disclosure with integrated filtering tailored to match the MED for skin types I through VI.

FIG. 4 shows photographs showing the reversible color transition of a photoPUSH composite prepared in accordance with certain aspects of the present disclosure having photochromic component (11.4 wt. % PMA) upon oxidation with an aqueous solution of hydrogen peroxide followed by drying.

FIGS. 5A-5E. FIG. 5A shows stability under 100% strain of (i) photochromic PMA deposited directly on a PUSH substrate, (ii) a PMA layer encapsulated between two PUSH layers, and (iii) a homogeneous photoPUSH composite film. FIG. 5B shows tensile stress-strain curves of pristine and healed PUHD, pristine and healed PUSH films, pristine and healed photoPUSH with 5.7 wt. % PMA. The polymer films were healed at 70° C. for 24 hours. FIG. 5C shoes a dog-bone specimen composed of healed PUSH (transparent) and photoPUSH (blue) being stretched to failure and fractured at random pristine locations. FIG. 5D shows an “M”-shaped photoPUSH film was bonded to a PUSH film by healing at 70° C. for 24 hours. The “M” photoPUSH film was manipulated by twisting, bending, and stretching with an elongation of 140%, showing no visible damage or delamination. FIG. 5E shows an “M” photoPUSH being cut into separate pieces and subsequently healed at 70° C. for 24 hours. The healed photoPUSH was stretched to 150% strain with no visible damage or delamination.

FIGS. 6A-6E. FIG. 6A shows adhesion pull-off measurements of PUSH films as a function of contact time. FIG. 6B shows reversible adhesion of PUSH over several adhesion cycles (Cycles 1 to 3). FIG. 6C shows adhesion of PUSH to a variety of common household substrates. FIG. 6D shows a UV-sensing sticker formed of a patterned photochromic photoPUSH layer bonded to a PUSH adhesive layer prepared in accordance with certain aspects of the present disclosure, used for environmental UV light monitoring demonstrated by a color change on a window. FIG. 6E shows a PUSH-based UV-sensor sticker prepared in accordance with certain aspects of the present disclosure for enclosure light monitoring in packaging applications. In FIG. 6E(i), the sticker is disposed on an interior surface/lid of a box in the dark for 24 hours and shows no discernable color change. On the other hand, FIG. 6E(ii) shows the sticker disposed on an interior surface where the box is opened and exposed to UV radiation and becomes progressively darker in color.

FIGS. 7A-7D show PUSH-based UV-monitoring wearables prepared in accordance with certain aspects of the present disclosure. FIG. 7A shows a PUSH-based UV detection patch including a photoPUSH sensing layer (1) and three distinct saturated controls for colorimetric reference (2-4). FIG. 7B shows a skin-mounted UV detection patch with FIG. 7B(i) displaying color change upon UV irradiation and in FIG. 7B(ii) displaying a color change while being waterproof. FIG. 7C shows a textile-mounted PUSH-based UV detector prepared in accordance with certain aspects of the present disclosure with a color change occurring upon UV irradiation. FIG. 7D shows a PhotoPUSH-based UV detection wristband containing UV detector and reference bands on a PUSH wristband. FIG. 7E shows the UV detection wristband changes color upon UV irradiation in FIG. 7E(i) on white background and FIG. 7E(ii) on human skin. In FIG. 7E(iii)m the self-healing UV detection wristband was cut into two piece and subsequently healed, showing no loss of function and no visible damage upon stretching.

FIG. 8 shows reversible photochromism of a self-healing PUSH composite film having a photochromic component comprising 1,3,3-trimethylindolino-6′-nitrobenzopyrylospiran (SP) upon UVA light (λmax=365 nm) irradiation with a M-shaped photomask and heating at 60° C.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

As referred to herein, the word “substantially,” when applied to a characteristic of a composition or method of this disclosure, indicates that there may be variation in the characteristic without having a substantial effect on the chemical or physical attributes of the composition or method.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

As used herein, unless otherwise indicated, amounts expressed in weight and mass are used interchangeably, but should be understood to reflect a mass of a given component.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated.

Example embodiments will now be described more fully with reference to the accompanying drawings.

In various aspects, the present disclosure provides a composition for detecting ultraviolet (UV) radiation comprising a polymer having an electron donor functional group. The composition also comprises a photochromic component, which may be distributed in the polymer. The photochromic component is configured to display a color change when exposed to ultraviolet radiation. In various aspects, a photochromic component undergoes a photochromic reaction in the presence of the UV radiation, for example, by absorbing UV radiation and thus changing the photochromic component from a first state with a first absorption spectra to a second state with a second absorption spectra distinct from the first spectra. As noted above, ultraviolet light may encompass electromagnetic radiation having wavelengths ranging from greater than or equal to about 100 nm to less than or equal to about 400 nm, including UV-A, typically ranging from greater than or equal to about 315 nm to less than or equal to about 400 nm, UV-B, typically ranging from greater than or equal to about 280 nm to less than or equal to about 315 nm, and UV-C, typically ranging from greater than or equal to about 100 nm to less than or equal to about 280 nm. As used herein, a photoreaction may encompass photoreactions of functional groups in a photochromic component's molecular structures or charge transfer in redox reactions. In this manner, the photochromic component exhibits a discernable difference or change in color/hue and/or saturation/intensity (generally referred to herein as “color change.”) Such a color change may be detected by visual observation, for example, by a subject like a human, or by a detector, for example, measuring ΔE* or other quantifiable color differences under International Commission on Illumination (CIE) metrics. Such a photochromic reaction and color change may be reversible, such that the photochromic component may revert back to the first state with the first spectra in the absence of UV light after having been in the second state with the second spectra when UV light was present.

In certain aspects, the photochromic component is distributed in the polymer having the electron donor functional group, so that the photochromic component is in proximity to the electron donor groups, which promote a photochromic reaction of the photochromic component in the presence of the UV radiation. In certain aspects, the photochromic component is a polyoxometalates (POMs) and more specifically, a subset of a POM in the form of a heteropolymetalate that includes three or more transition metal oxyanions linked together by shared oxygen atoms to form a closed three-dimensional molecular framework. Such a heteropolymetalate may be phosphomolybdic acid hydrate (PMA) having associated water molecules (e.g., water molecules trapped in its crystals). Unless otherwise specified, phosphomolybdic acid (PMA) is used generically to encompass both phosphomolybdic acid and phosphomolybdic acid hydrate (PMA). In certain aspects, the photochromic component may be selected from the group consisting of: phosphomolybdic acid (PMA), which may include hydrates of phosphomolybdic acid (PMA), spiropyrans, for example, 1,3,3-trimethylindolino-6′-nitrobenzopyrylospiran (SP), and combinations thereof. In certain variations, the photochromic component is phosphomolybdic acid (PMA) (including hydrates thereof), which performs especially well in exhibiting sustained, non-fading color after exposure to UV light. Phosphomolybdic acid (PMA) can be used a UV-sensing nanofiller in the composition by taking advantage of its photochromic properties and resulting color change upon exposure to UV light. The color change of PMA can be activated with electron donating groups under UV light exposure resulting in a reduction of the PMA.

In certain variations, the electron donor functional group comprises a disulfide group. This contributes electrons to the nearby photochromic acid in the composition when UV radiation is present, thus serving to promote and facilitate the photochromic reaction that results in the color change. In this manner, the composition may be substantially free or free of any dopants, catalysts, or other additives that would typically be required for the photochromic component to undergo a color change in the presence of UV light. The term “substantially free” as referred to herein is intended to mean that the compound or species is absent to the extent that undesirable and/or detrimental effects are negligible or nonexistent. In certain aspects, a composition that is “substantially free” of such compounds comprises less than or equal to about 0.5% by weight, optionally less than or equal to about 0.1% by weight, optionally less than or equal to about 0.01% by weight, and in certain preferred aspects, 0% by weight of the undesired species, like an added dopant.

As noted above, the photochromic component, like PMA or 1,3,3-trimethylindolino-6′-nitrobenzopyrylospiran (SP), undergoes a photochromic reaction and color change to a second state with a second spectra when UV light is present that may be reversible, such that the photochromic component may revert to the first state with the first spectra. The PMA and SP have different photochromic reactions and mechanisms. While both change from a first state to a second state in which they have changed color after exposure to UV, PMA typically undergoes a change to exhibit dark blue, while SP exhibits violet. Under various conditions, PMA may be more stable than SP. The color change for SP to violet is lighter (less intense) and can be reversed from the second state of violet to the first transparent state by being exposed to mild heat or relatively low elevated temperatures (due to this lower stability). The color change for PMA is more stable and can retain color for longer time, which may be desired for measuring UV doses. PMA cannot be reversed from the second state to the first state with temperature alone, but can be reversed chemically (through a reversible oxidation reaction, for example, with hydrogen peroxide).

Therefore, in certain variations, the photochromic component of the composition can be subjected to a regeneration process to reverse the color change. By way of example, in one variation, the color change can be reversed by contacting the composition comprising the photochromic component with an oxidant, such as hydrogen peroxide (H2O2), for a duration sufficient to reverse the photochromic reaction, for example, greater than or equal to about 24 hours, and change the color from a second state back to its initial first state. In one variation, the composition may be reversed chemically by immersing the photochromic composite/composition in an aqueous solution of hydrogen peroxide (H2O2). For example, when PMA is the photochromic compound, in the second state after exposure to UV light, the composition exhibits a blue color. The decoloration of the blue-colored composition back to the first state without any color may be caused by an oxidation reaction, in which hydrogen peroxide oxidizes the photochromic compound (e.g., that had been previously reduced during the initial photochromic reaction when it turned blue). Notably, the oxidized composite comprising a photochromic component in the form of PMA maintains its photochromic properties and exhibits color change from colorless to blue again upon renewed UV exposure.

In other alternative variations, the color change can be reversed by exposing the composition comprising the photochromic component to an environment with an elevated temperature, for example, at greater than or equal to about 60° C. for a duration sufficient to reverse the photochromic reaction, for example, greater than or equal to about 3 minutes, to change the color from a second state back to its initial first state. The reversibility of the photochromism in the composites therefore enable its use for multiple cycles.

In various aspects, the polymer is self-healing. Self-healing is generally understood to be the ability of a material to recover itself upon damage, such as mechanical damage. Self-healing materials can improve the lifetime, recyclability, durability, energy efficiency, and safety of synthetic materials. For example, autonomous self-healing materials are capable of repairing themselves when mechanically damaged or chemically corroded. Certain self-healing materials react in situ to heal. Synthetic materials with self-healing properties are highly desirable for a variety of applications, including self-healing adhesives, self-healing sensors, self-healing coatings, and the like that can be used in a variety of applications, including electronic devices, medical devices, and the like. Self-healing polymers may employ hydrogen bonds and disulfide bonds. Autonomous self-healing materials capable of repeatable self-healing ability at ambient conditions, along with extended environmental stability, are highly desirable. The self-healing composite comprising the self-healing polymer may have a healing efficiency defined as a ratio of a tensile strength of a self-healed sample to a tensile strength of a pristine sample. In certain aspects, the composition comprising the self-healing polymer may exhibit a healing efficiency of greater than or equal to about 90%, optionally greater than or equal to about 95%, optionally greater than or equal to about 96%, and in certain variations, optionally greater than or equal to about 97%.

The polymer may also be elastomeric. The elastomeric material may stretchable and/or flexible (e.g., capable of bending in normal use without mechanical failure). By “stretchable” it is meant that materials, structures, components, and devices are capable of withstanding high levels of strain, without fracturing or other mechanical failure. Stretchable or flexible materials in accordance with certain aspects of the present disclosure are extensible and thus are capable of stretching and/or compression, at least to some degree, without damage, mechanical failure or significant degradation in performance. Moreover, if damage is sustained, the polymer has the self-healing properties described above to repair itself. In certain variations, the elastomeric polymer may have an elastic modulus or Young's Modulus of less than or equal to about 28 MPa, for example, a range of greater than 0 to less than or equal to about 28 MPa.

The polymer may create a polymer matrix formed from any kind of suitable precursor or resins. Thermoset resins are cured from a liquid precursor to form the polymer, which may serve as a matrix in a composite. For thermoplastic elastomeric polymer matrix materials, the polymers may be melted to a liquid state or dissolved in a solvent to form a solution before the photochromic component and any other additives are introduced to create a composite. The polymeric elastomer may be a thermoset, such as polyurethane (PU) and copolymers and derivatives thereof. By way of non-limiting example, in certain variations, the polymer precursors may include polytetrahydrofuran (PTHF) and 4,4′-methylenebis(cyclohexyl isocyanate) (HMDI), which may be combined to form a prepolymer. In one variation, the PTHF may have a molecular number (Mₙ) of approximately 1000 g mol⁻¹.

For example, the polyurethane (PU) is functionalized to include disulfide functional groups that serve as electron donor functional groups. Thus, the prepolymer may then be reacted with a precursor of the electron donor function group, for example, 2-hydroxyethyl disulfide (HEDS), to react with the precursor to form a functionalized polyurethane having disulfide functional groups incorporated therein. In one variation, the precursors of the self-healing elastomeric polymer having the electron donor functional group may include polytetrahydrofuran (PTHF), 4,4′-methylenebis(cyclohexyl isocyanate) (HMDI), and 2-hydroxyethyl disulfide (HEDS).

Dynamic disulfide bonds incorporated into the elastomer are of particular utility in the context of the present compositions, because they exhibit excellent self-healing, for example, exhibiting a healing efficiency of greater than or equal to about 95%, at moderate temperatures (for example, at greater than or equal to about 25 to less than or equal to about 80° C.) due to a low bond dissociation energy. Moreover, disulfide functional groups can be introduced into polyurethane polymers to confer healing properties to the network, while retaining optical transparency required for transmitting UV-radiation. The composites provided by certain aspects of the present disclosure advantageously provide concurrent advantages of both providing a robust, self-healing elastomeric composite, while concurrently providing electron donor groups that can act as UV-sensing enablers.

The composition may include the photochromic component present at greater than or equal to about 0.1 % by weight to less than or equal to about 40% by weight of the composition, optionally at greater than or equal to about 1% to less than or equal to about 35% by weight, optionally greater than or equal to about 2% by weight to less than or equal to about 25%, optionally greater than or equal to about 3% by weight to less than or equal to about 25%, optionally greater than or equal to about 5% by weight to less than or equal to about 20%, and in certain aspects, optionally greater than or equal to about 5% by weight to less than or equal to about 15%. In certain aspects, the photochromic component may be homogeneously distributed within the elastomeric polymeric matrix. The self-healing elastomeric polymer is present at greater than or equal to about 60 % by weight to less than or equal to about 99.9% by weight of the composition, optionally at greater than or equal to about 65% to less than or equal to about 99% by weight, optionally greater than or equal to about 75% by weight to less than or equal to about 98%, optionally greater than or equal to about 75% by weight to less than or equal to about 97%, optionally greater than or equal to about 80% by weight to less than or equal to about 95%, and in certain aspects, optionally greater than or equal to about 85% by weight to less than or equal to about 95%.

The composite material may have an additional reinforcing or filler material in the form of fibers or particles (e.g., carbon particles or fibers, nanotubes, glass fibers, and the like) dispersed in a polymeric matrix of the self-healing elastomeric polymer. The reinforcing material (e.g., fibers) may be present in the polymeric composite at greater than or equal to about 25% by volume to less than or equal to about 70% by volume, optionally greater than or equal to about 35% by volume to less than or equal to about 60% by volume where the polymeric matrix may be present at greater than or equal to about 30% by volume to less than or equal to about 70% by volume, optionally about greater than or equal to about 40% by volume to less than or equal to about 65% by volume. In certain aspects, the reinforcing material may be homogeneously distributed within the polymeric matrix.

The self-healing composite material may further include other conventional ingredients, including other reinforcement materials, functional fillers or additive agents, like organic/inorganic fillers, fire-retardants, UV stabilizers, antioxidants, colorants or pigments, such as carbon black powder, mold release agents, softeners, plasticizing agents, surface active agents, and the like. In certain variations, UV-absorbing particles may be added to the composite materials to partially absorb UV energy, similar to a UV filter, which can customize the responsiveness and kinetics of the sensor.

The composition, including the self-healing elastomeric polymer, is optically transparent to radiation in a select range of wavelengths. By transparent, it is meant that a layer of the composition is transmissive for a target range of wavelengths of electromagnetic energy, for example, in the ultraviolet wavelength ranges of 100 nm to 400 nm. Further, the composition may be transparent to wavelengths in the visible range (e.g., having wavelengths ranging from about 390 to about 750 nm), so that the color change in the composition is visible external to the composition. Thus, in certain aspects, a transparent composition transmits greater than or equal to about 60% of electromagnetic energy at the predetermined range of wavelengths, optionally of greater than or equal to about 65%, optionally greater than or equal to about 70%, optionally greater than or equal to about 75%, optionally greater than or equal to about 80%, optionally greater than or equal to about 85%, optionally greater than or equal to about 90%, and in certain preferred aspects, optionally greater than or equal to about 95% of the electromagnetic energy at the predetermined range of wavelengths (e.g., in the visible and/or ultraviolet ranges of the spectrum) is transmitted.

The compositions/composites prepared in accordance with certain aspects of the present disclosure may be formed by solution blending and casting processes. The compositions may be made by any conventional film-forming process, such as solution casting. Suitable solvents for solution casting may permit the layer to be cast over a substrate, followed by drying (with optional heating). After formation, the composition may form a dried layer having a thickness of greater than or equal to about 1 micrometer to less than or equal to about 5 mm, and in certain aspects, optionally greater than or equal to about 20 micrometers to less than or equal to about 300 micrometers.

In certain variations, the composition includes a self-healing elastomeric polymer comprising a polyurethane having an electron donor functional group that comprises a disulfide group. The composition also includes a photochromic component comprising phosphomolybdic acid, where photochromic reaction promotes reduction of molybdenum (Mo) in the phosphomolybdic acid (e.g., from a valence of VI in a first state to a valence of V in a second state) in the presence of the ultraviolet radiation.

The composition can detect radiation where the ultraviolet radiation is selected from the group consisting of: UVA, UVB, UVC, and combinations thereof. The color change may reflect cumulative exposure to ultraviolet radiation. In certain aspects, the at least one detection region has a sensitivity to ultraviolet radiation at an intensity of greater than or equal to about 2 mW/cm² to less than or equal to about 5.6mW/cm².

The present disclosure thus contemplates in certain aspects, a new photochromic elastomer composite capable of UV-sensing/detection that integrates the colorimetric properties of a photochromic component, like phosphomolybdic acid, into a multifunctional polyurethane polymer network with dynamic disulfide bonds. The unique dynamic properties of the polymer network enable multiple synergistic functions in the UV-sensing composite, including by way of non-limiting example: (i) photochromism via electron donor groups without requiring additional dopants, (ii) stretchability and durability via elastomeric properties, (iii) healing of extreme mechanical damage via dynamic bonds, and/or (iv) multimaterial integration via adhesive properties. Each of these properties individually outperform current materials in state-of-the-art soft and flexible photochromic sensors and combined together through materials design result in multifunctional elastomer composites with synergistic properties and excellent durability, tunable sensing range, and no loss of performance under mechanical stress and severe damage, as well as providing water resistant/water-proof capabilities in underwater environments. The advantages of this material system are demonstrated in soft, portable, multimaterial UV-sensing devices, including scratch-resistant sensor stickers and skin-mounted, textile-mounted, and smart wristband wearable devices tunable to different skin type sensitivity. The compositions provided in various aspects by the present disclosure demonstrate the versatility, durability, tunability, and scalability of the inventive materials system as a stretchable sensing platform, which can be applied to new soft sensor designs in portable environmental monitoring, food security, smart packaging, and healthcare wearable (e.g., including skin-mounted, textile-mounted, and wristband devices) technology, among others.

In certain aspects, the present disclosure contemplates a product for detecting ultraviolet (UV) radiation. The product includes at least one detection region configured to receive and display a color change after exposure to ultraviolet (UV) radiation. The detection region has a composite material like any of those described above, for example, comprising a self-healing elastomeric polymer matrix comprising an electron donor functional group and a photochromic component distributed in the polymer matrix. The electron donor functional group may promote a photochromic reaction of the photochromic component in the presence of the ultraviolet radiation. The at least one detection region may have a variety of shapes and sizes, for example, rectangular, square, round (e.g., circular, oval, etc.), or customized shapes to define various indicia (e.g., logos, text). The product may further include at least one reference region in proximity with the at least one detection region. The at least one reference region also comprises the self-healing elastomeric polymer matrix comprising the electron donor functional group and the photochromic component. The at least one reference region has a first color indicating exposure to a predetermined amount of ultraviolet radiation that can be compared to a second color of the at least one detection region for determining an exposure level of the at least one detection region to ultraviolet radiation. The at least one reference region may have a variety of shapes and sizes, for example, rectangular, square, round (e.g., circular, oval, etc.), or customized shapes to define various indicia.

In certain variations, the product may include multiple reference regions which can provide reference points for comparison with different predetermined amounts of exposure to UV radiation. For example, in certain variations, the product may comprise at least two reference regions. A first reference region has a first amount of the photochromic component while a second reference region has a second amount of the photochromic component. The first amount is greater than the second amount. In this manner, the first reference region may be darker in color than the second reference region. Thus, the second reference region may indicate a lower amount of UV exposure and the first reference region may indicate a larger/longer amount of exposure to UV radiation when compared to the detection region as it is progressively exposed to more UV radiation.

In certain variations, the at least one detection region is a layer (or a portion of a layer in a predetermined shape) disposed in or on/over a layer of the self-healing elastomeric polymer matrix comprising an electron donor functional group where the photochromic component is absent. The product may further include at least one layer of adhesive disposed below the at least one detection region, so that the product may be adhered to an underlying substrate (e.g., skin, textile, glass, paper, cardboard, fabric, polymers/plastic, metal, and the like). The adhesive may be a pressure-sensitive adhesive and may be provided in a layer or in discrete regions to facilitate adherence to the underlying substrate. In certain variations, the product may be a multilayered structure. For example, a first layer may include the at least one detection region, an intermediate layer defines a first side adjacent to the first layer and a second side opposite to the first layer. The intermediate layer comprises the self-healing elastomeric polymer matrix comprising an electron donor functional group where the photochromic component is absent. A third layer is then disposed adjacent to the second side of the intermediate layer and may comprise the adhesive. A cover layer of transparent material may be disposed over the at least one detection region to protect it from the external environment. The cover layer may include a self-healing elastomeric polymer matrix comprising an electron donor functional group where the photochromic component is absent or other optically transparent and water-proof material.

In certain variations, at least one layer of an ultraviolet radiation filter is disposed over the at least one detection region. The ultraviolet radiation filter may comprise a polymer and can enable tuning of the sensitivity of the underlying detection region, as described further below. In certain variations, the ultraviolet radiation filter may comprise polyethylene terephthalate (PET) film, by way of example. Such a filter may have a thickness of greater than 0 to less than or equal to about 800 micrometers, optionally greater than 0 to less than or equal to about 500 micrometers, and in certain variations, optionally greater than 0 to less than or equal to about 200 micrometers.

The product may be a wearable product that can be removably affixed to a user (e.g., by a mechanical self-coupling or adhesive). The at least one detection region of the wearable product is exposed to the external environment where UV radiation may be present and is visible to the user, so that the color change is displayed for the user. The detection region may be capable of detecting ultraviolet radiation selected from the group consisting of: UVA, UVB, UVC, and combinations thereof. The color change may reflect cumulative exposure to ultraviolet radiation. In certain aspects, the at least one detection region has a sensitivity to ultraviolet radiation at an intensity of greater than or equal to about 2 mW/cm² to less than or equal to about 5.6mW/cm². In certain variations, the product is selected from the group consisting of: a sticker, a wristband, a patch, and combinations thereof. The product is waterproof, free of any batteries. Further, the wearable product may be reusable, so that the color change is reversible after the at least one detection region is regenerated and thus capable of detecting exposure to ultraviolet radiation multiple (e.g., at least two) times.

In yet other aspects, the present disclosure contemplates methods for detecting ultraviolet (UV) radiation. The method may comprise disposing a product having at least one detection region in an environment where UV radiation may be present. The at least one detection region may be any of those described previously above, for example, comprising a composite material comprising a self-healing elastomeric polymer matrix comprising an electron donor functional group and a photochromic component distributed in the polymer matrix, where the electron donor functional group promotes a photochromic reaction of the photochromic component in the presence of the ultraviolet radiation. The method further comprises detecting exposure to UV radiation after the at least one detection region of the product displays a color change.

In certain aspects, the product may be any of those described above, so that the product may further comprise at least one reference region in proximity with the at least one detection region. The at least one reference region also comprises the composite material comprising the self-healing elastomeric polymer matrix comprising the electron donor functional group and the photochromic component. The at least one reference region has a first color indicating exposure to a predetermined amount of ultraviolet radiation and the detecting further comprises comparing the first color to a second color reflecting the color change of the at least one detection region for determining an exposure level of the at least one detection region to ultraviolet radiation.

In certain aspects, the product is selected from the group consisting of a sticker, a wristband, a patch, and combinations thereof. The method may further comprise after the detecting, regenerating the product by subjecting the product to a regeneration cycle by exposing the product to at least one of heat, energy, or exposure to an oxidant. A suitable oxidant includes peroxide (H₂O₂), by way of example. The regenerating may include contacting the product comprising the photochromic component with an oxidant, such as hydrogen peroxide (H₂O₂), for a duration sufficient to reverse the photochromic reaction and change the color from a second state back to its initial first state. In one variation, the composition may be reversed chemically by immersing the photochromic composite/composition in an aqueous solution of hydrogen peroxide (H₂O₂). For example, when PMA is the photochromic compound, in the second state after exposure to UV light, the composition exhibits a blue color. The decoloration of the blue-colored composition back to the first state without any color may be caused by an oxidation reaction, in which hydrogen peroxide oxidizes the photochromic compound (e.g., that had been previously reduced during the initial photochromic reaction when it turned blue). Notably, the oxidized composite comprising a photochromic component in the form of PMA maintains its photochromic properties and exhibits color change from colorless to blue again upon renewed UV exposure. The reversibility of the photochromism in the composites therefore enable its use for multiple cycles. In this manner, the product can be reused when the at least one detection region is regenerated and is capable of the detecting exposure to UV radiation again.

The method may further comprise healing any mechanical damage to the product by subjecting the product to a self-healing cycle by exposing the product to at least one of heat or energy. While those of skill in the art recognize that a variety of temperatures and times can be used for self-healing, in one example, a self-healing cycle may comprise heating the product comprising the self-healing polymer in an environment having a temperature of about 70° C. for about 24 hours.

By way of further background, as noted above, most commercial UV-sensors are electronic solid-state devices that are rigid and fragile, which limit their portability and use. Current wearable UV sensing technologies can be categorized as photoelectric or photochromic systems. Photoelectric sensors are typically composed of photodetectors, which rely on sensing through conversion of UV irradiation to electric current via photoexcitation of electrons in band gap of semiconductor materials. For example, photodetectors have integrated metal oxides (such as zinc oxide, titanium dioxide, Tin (IV) oxide, and vanadium pentoxide) or multielement alloys (such as indium gallium nitride and aluminum gallium nitride) to adjust their bandgap energy or charge carrier transport channels, resulting in enhanced wavelength selectivity or photoresponse, respectively. Nevertheless, photoelectric sensors must transform photocurrent into measurable electronic signals, and therefore require additional electronic components (such as spectroradiometers) that complicate their miniaturization and their integration into wearable devices. Furthermore, these additional components make the sensors rigid, fragile, and with limited application in wearable technology.

On the other hand, photochromic sensors do not require additional electronic components for a direct visual colorimetric measurement, and they can be integrated in soft, flexible, and conformable materials, which makes them more attractive for the development of soft wearable sensors and devices. Photochromic sensors undergo a color change upon UV light exposure due to photoreactions of functional groups in their molecular structures or charge transfer in redox reactions. Polyoxometalates (POMs) are photochromic materials suitable for UV-sensors owing to their fast multi-electron transfer reactions upon UV irradiation, long-term photochemical stability, and good sensitive coloration. The charge transfer reactions between POMs and electron donors induce a reduction of the central metals in POMs, resulting in a deep-blue color for UV-sensing function. Because of this mechanism, POM-based sensors require additional chemicals as electron donor groups to activate the color change in the system, which can be incorporated either as additives (lactic or citric acids) in paper-based sensors or as polymer matrices in composite systems (such as poly(acrylic acid), polyvinylpyrrolidone, polyacrylamide, poly(ethylene glycol), and cellulose). However, although flexible, the resulting earlier POM-based sensors exhibit low durability due to the low mechanical strength and stability of these polymer matrices and fillers, and are therefore vulnerable to mechanical damage, scratches, and exposure to environmental factors (such as water) that deteriorate their performance.

While self-healing soft materials relying on dynamic covalent bonds and reversible crosslinking mechanisms have been implemented in soft devices in an array of applications ranging from information storage to sensing to robotics, many self-healing polymers present fundamental materials challenges to perform effectively in wearable photochromic applications. For example, such materials should have a high healing efficiency to recover their properties without loss of function, resist common chemical hazards relevant to their use (insensitive to water and other environmental factors), and should be optically transparent to enable photochromic sensing.

The inventive technology provided herein addresses these durability and vulnerability challenges, by providing self-healing soft materials that enable resilient UV-sensing devices that can reliably perform in realistic environments. Thus, in certain aspects, a new type of multifunctional photochromic elastomer composite with self-healing and UV-responsive properties is provided that incorporates a photochromic component, like phosphomolybdic acid (PMA), into a self-healing polyurethane (PUSH) polymer network functionalized with dynamic disulfide bonds. The integration of PMA in PUSH polymers results in synergistic properties and capabilities that are not achieved with other material combinations, including by way of non-limiting example, the following: (i) provides electron donor functional groups to enable the photochromic mechanism and UV-sensing capabilities, thus eliminating the need for electron donor additives, (ii) enables the fabrication of composites by directly dispersing the active photochromic component into a mechanically stable and protective matrix, eliminating the dependence on other substrates, (iii) provides healing properties to the nanocomposite, with high healing efficiency and recovery of functions even after extreme mechanical damage, (iv) provides adhesive properties to a variety of surfaces to enable the use as smart photochromic sticker sensors, and (v) enables the interfacial bonding of PUSH-based materials with different compositions, allowing for the fabrication of stretchable multimaterial devices without delamination or fracture limitations. The self-healing photochromic polyurethane elastomers composites having a photochromic component incorporated (photoPUSH) provided in accordance with certain aspects of the present disclosure exhibit programmable sensitivity to UV light, displaying a visual color change through photoreduction of PMA molecules without adding additives, as well as excellent durability to mechanical stress, water-resistance, and healing efficiency (for example, greater than or equal to about 97%). By tailoring the composition, photoPUSH soft composites were designed with a programmable photochromic response for a broad range of UV doses, thus providing a sensing platform for the safe UV exposure threshold for different skin types. We demonstrate the application of the photoPUSH composites as adhesive sensor stickers for environmental monitoring and for of skin-mounted, textile-integrated, and bracelet type wearable sensors.

Various embodiments of the inventive technology can be further understood by the specific examples contained herein. Specific Examples are provided for illustrative purposes of how to make and use the compositions, devices, and methods according to the present teachings and, unless explicitly stated otherwise, are not intended to be a representation that given embodiments of this invention have, or have not, been made or tested.

### EXAMPLE 1

The following materials are used to form compositions according to certain aspects of the present disclosure. Polytetrahydrofuran (PTHF, Mn approximately 1000 g mol⁻¹) was dried at 120° C. under vacuum for 2 hours before use. 2-hydroxyethyl disulfide (HEDS, ≥85.0%), dibutyltin dilaurate (DBTDL, 95%), 4,4′-methylenebis(cyclohexyl isocyanate) (HMDI, 90.0%), 1,6-hexanediol (HDO, 99%) tetrahydrofuran (THF, ≥99.9%), N,N-dimethylacetamide (DMAc, ≥99.0%), phosphomolybdic acid hydrate (PMA), 2-propanol (IPA, ≥99.5%) were purchased from Sigma Aldrich and were used as received. 1,3,3-trimethylindolino-6′-nitrobenzopyrylospiran (SP, >98.0%) was purchased from TCI Chemicals.

Gel permeation chromatography (GPC, Shimadzu) was performed to estimate the apparent molecular weight of polymers with a refractive index detector and three columns arranged in series (3 Phenomenex Phenogel™ 10 μm Linear (2), LC Column 300×7.8 mm). Polymer solutions in THF were filtered through a 0.45 μm pore size PTFE membrane filter and measured at 40° C. with a flow rate of 1 mL min⁻¹. The system was calibrated with linear polystyrene standards. Fourier transform infrared spectroscopy (FTIR) spectra were recorded using a FTIR spectrometer (Nicolet iS20, Thermo Fisher Scientific) on Attenuated total reflectance (ATR) mode with a wavenumber range of 400-4000 cm⁻¹ by 32 scans at a resolution of 4 cm⁻¹. Transmittance spectra were recorded using a UV-vis spectrometer equipped with a 60 mm collection integrating sphere (Lambda 750S, PerkinElmer).

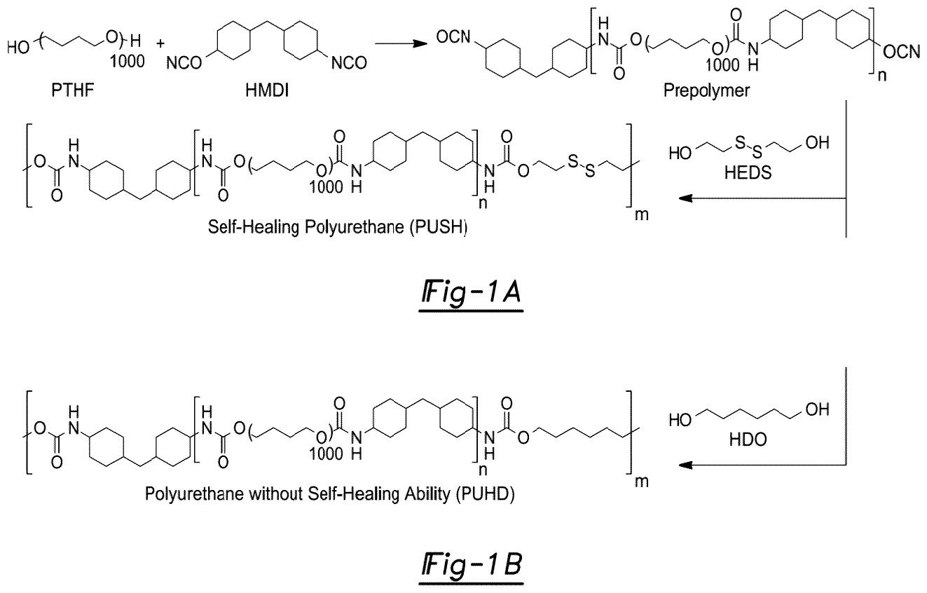

A functionalized polyurethane elastomer prepared in accordance with certain aspects of the present disclosure was synthesized as follows. The reaction mechanism is shown in FIG. 1A. PTHF (20.1 g, 20.1 mmol) was melted at 70° C. in a 500 mL round bottom flask connected to a digital overhead stirrer (RealTorqueDigital™, Fisherbrand) with a polytetrafluoroethylene-coated propeller. HMDI (15.3 mL, 62.8 mmol) was then added into the flask and stirred to give a well-mixed mixture, followed by addition of DBTDL (38 μL, 0.06 mmol). After 2 hours, a viscous prepolymer solution was obtained and diluted with DMAc (80 mL).

The dynamic disulfide functional groups are then incorporated into the polymer by introducing HEDS (5.1 mL, 41.7 mmol) that was charged into the solution. The reaction was allowed to proceed at 70° C. for another 16 hours to obtain a self-healing polyurethane (PUSH) having disulfide functional groups incorporated therein. The solution of PUSH after reaction was diluted with DMAc (90 mL).

For comparison, a polyurethane without self-healing ability (PUHD) was also prepared as shown in reaction mechanism of FIG. 1B following the same aforementioned procedure with PTHF (20.3 g, 20.3 mmol), HMDI (15.4 mL, 63.2 mmol), HDO (5.0 g, 42.7 mmol), and DMAc (100 mL) during 12 h of reaction and that DMAc (50 mL) and THF (20 mL) were used for diluting the polymer solution after reaction. The apparent weight-average molecular weight (M_{w}), the apparent number-average molecular weight (Mₙ), and the molecular weight distribution (MWD) of the PUSH prepared in accordance with certain aspects of the present disclosure were 77,800 g mol⁻¹, 38,000 g mol⁻¹, and 2.05, respectively. The M_{w}, Mₙ, and MWD of the comparative PUHD were 153,800 g mol⁻¹, 81,500 g mol⁻¹, and 1.89, respectively. The diluted polymer solutions were dried at 60° C. in a vacuum oven for 5 days to obtain polymer films for further experiments.

Photochromic properties of PMA (photochromic component) on different substrates were evaluated as follows. Solutions of PMA in IPA (2 μL) with different concentrations (1.0, 2.5, and 5.0 mM) were dropped on different substrates (PUSH, PUHD, borosilicate glass, polyethylene terephthalate or PET, polystyrene or PS, ECOFLEX™, and SYLGARD 184™polydimethylsiloxane or PDMS) using a 10-μL pipette tip. It was noted that a drop of the PMA solution on borosilicate glass, PET, PS, and PDMS was confined in a circular PDMS cavity (diameter of approximately 3 mm) to restrict spreading of the solution. The PMA solutions on substrates were dried at 25° C. for 24 h, followed by heating at 70° C. for 24 hours and subjecting to UVA exposure at different times (180, 300, 600, and 900 seconds).

Ultraviolet-visible (UV-vis) spectrophotometry measurements of self-healing photochromic films were obtained as follows. PUSH polymer prepared in accordance with certain aspects of the present teachings was dissolved in a solution of PMA (photochromic component) in DMAc with a concentration of 0.05, 0.1, 0.5, 0.8, 1.0, 2.5, 5.0, 10.0, and 15.0 mM, respectively at 25° C. for 20 h to prepare a solution of PMA/PUSH with a concentration of 0.08 g mL⁻¹. A solution of PUSH in pure DMAc (0.08 g mL⁻¹) was used as a control sample. The obtained solutions of PMA/PUSH in DMAc (250 μL) were cast on glass substrates (2.5 cm×2.5 cm×1.0 mm), followed by drying in the dark at 60° C. in a vacuum oven for 5 days to yield photochromic elastomeric films having photochromic PMA (photoPUSH) (thickness=0.02 mm) with 0.1, 0.2, 1.1, 1.8, 2.3, 5.7, 11.4, 22.8, and 34.2 wt. % PMA, respectively. UV irradiation on the specimens was performed in a UV light chamber (Fisherbrand) using 8-watt fluorescent tubes (USHIO America) with λmax at 368, 306, and 265 nm for UVA, UVB, and UVC lights, respectively. The specimens were irradiated with an average light intensity of 37±2, 54±3, and 56±4 W m⁻² for UVA, UVB, and UVC, respectively, which were monitored using an optical power meter (PM100A, ThorLabs) with a power sensor (S120VS, ThorLabs, aperture diameter=9.50 mm). The dose of UV light is a quantity of UV light intensity multiplied by exposure time. For the evaluation of sensitivity to UVA, B, and C, the photoPUSH films (5.7 wt. % PMA) on glass substrate were subjected to UVA, B, C light exposure with increasing UV doses from 0 to 400 kJ m⁻². For evaluation of photoPUSH with UV filters, the photoPUSH films were covered by UV filters (PET thin films) with different thickness (200, 400, 500, 600, and 800 μm), followed by exposure to UVA. UV-vis absorbances of the photoPUSH films were measured in triplicates using a microplate reader (Synergy HT, BioTek) at a wavelength range of 300-900 nm with increasing UVA exposure time from 0 -180 min. To study the effect of temperature on photochromism, the photoPUSH films (5.7 wt. % PMA, thickness of approximately 0.02 mm) were irradiated with an average UVA light intensity of 25±1 W m⁻² using a 365 nm UV lamp (5 watts, DARKBEAM) at different temperatures of 0 ° C. (Peltier cooling plate), 25° C., and 70° C. (hot plate) for 150 min.

Reversible color transition of photoPUSH composites is evaluated as follows. A photoPUSH composite (11.4 wt. % PMA) with blue color was immersed in an oxidizing solution (15 vol. % H₂O₂, 30 vol. % IPA, and 55 vol. % H₂O) at 25° C. for 16 hours, and dried at 60° C. under vacuum for 2 days.

Durability and mechanical properties of self-healing photochromic elastomer are evaluated as follows. A solution of PMA in IPA (2 μL, 10.0 mM) was dropped on two different PUSH films (thickness of approximately 0.24 mm), and then dried at 25° C. for 24 hours to obtain a deposition of PMA on the PUSH films. An encapsulation of PMA in PUSH was prepared by covering another PUSH film over the deposited PMA, followed by heating at 70° C. in an oven for 24 hours. PhotoPUSH samples were prepared by attaching a circular photoPUSH with 5.7 wt. % PMA (diameter approximately 3 mm) to a PUSH film, and then heating at 70° C. in an oven for 24 hours. All samples were stretched with an elongation of approximately 95% using a stretching device. Microscopy images were recorded using a digital microscope Dino-Lite AM73915MZTL (R10A) with an imaging software (Dinocapture 2.0). Samples for tensile test were prepared by casting a solution of PMA/PUSH (23 mL, 0.08 g mL⁻¹, 2.5 mM PMA in DMAc) on a glass petri dish (90 mm diameter), followed by drying in the dark at 60° C. in a vacuum oven for 5 days. PUSH and PUDH films were prepared by the same procedures for photoPUSH and used as control samples. The obtained polymer films were cut as dog-bone shaped specimens with an overall length of 30 mm, a gauge length of 10 mm, and a width of 5 mm. The healed samples for photoPUSH and pure PUSH were prepared by cutting the pristine films in half using a cutter blade, then the two pieces were put together again and healed at 70° C. in an oven for 24 hours. Mechanical tensile tests were performed in triplicates using a texture analyzer (TA.XT Plus, Stable Micro Systems) with a strain rate of 60 mm min⁻¹ at 25° C. The shear creep measurements were performed using a Discovery HR30 rheometer (TA Instruments) with upper parallel plate and UV curing accessories, which were equipped with an Omnicure series 1500 light source with a 320-390 nm UV light filter. A constant creep stress of 0.1 MPa was applied to PUSH films (Thickness approximately 0.3 mm) for 900 seconds at 25° C.

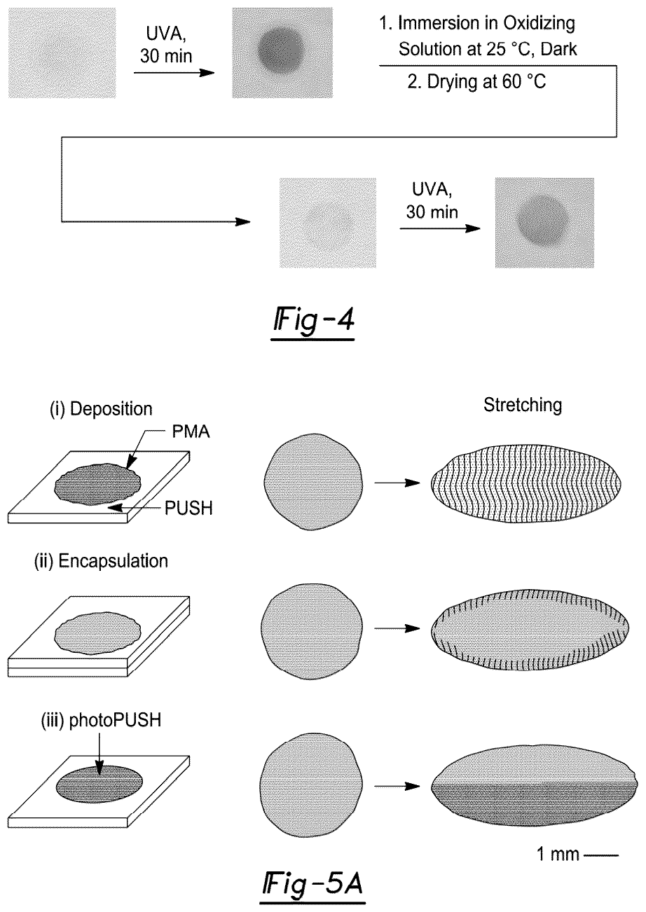

An adhesion test of a self-healing polymer to substrates is conducted as follows. The experiments were performed using the Discovery HR30 rheometer (TA Instruments) with parallel plates at 25° C. A circular PUSH film (diameter=10 mm, thickness=0.03 mm) and sample substrates (polystyrene (PS), glass, polyethylene (PE), polyethylene terephthalate (PET), stainless steel (SS), PUSH, paper, PDMS, sandpaper (1000 SiC grit), and cotton fabric) were adhered to the top plate and the bottom plate, respectively using a double-sided adhesive tape. The adhesion tests were performed with 3 steps (1 cycle) as illustrated in FIG. 4 a. The PUSH film was moving down with a velocity of 10 μm s⁻¹ to make a contact with the sample substrates until a compressive preload force of 2 N was reached (loading step). After a contact time of 10 seconds (contact step), the PUSH film was retracted from the sample substrates with a velocity of 10 μm s⁻¹ (unloading step). The pull-off stress was the ratio of a maximum force before detachment to the contact area between the PUSH film and the sample substrates. The adhesion measurements were repeated in triplicates.

### EXAMPLE 2

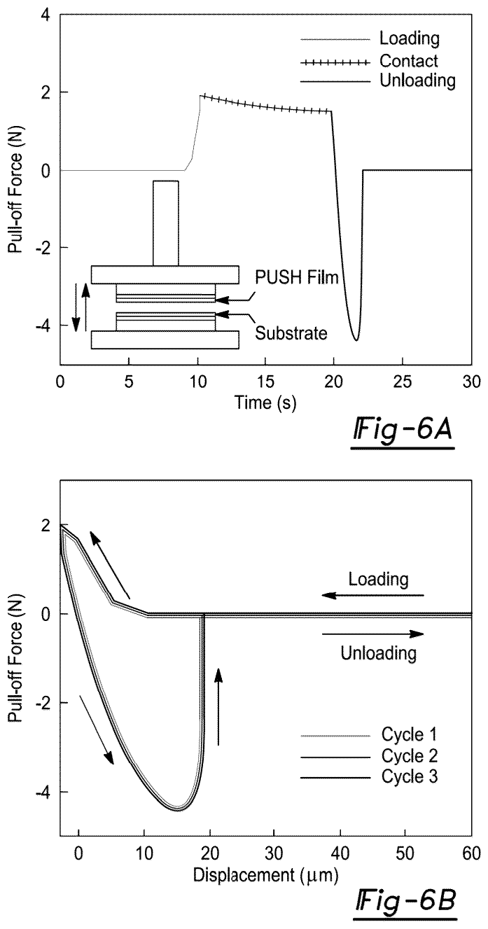

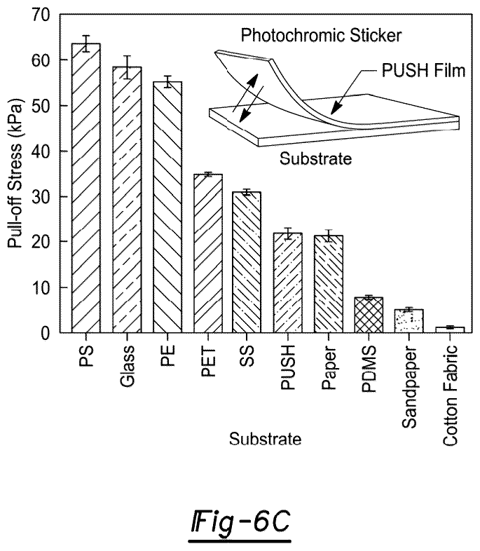

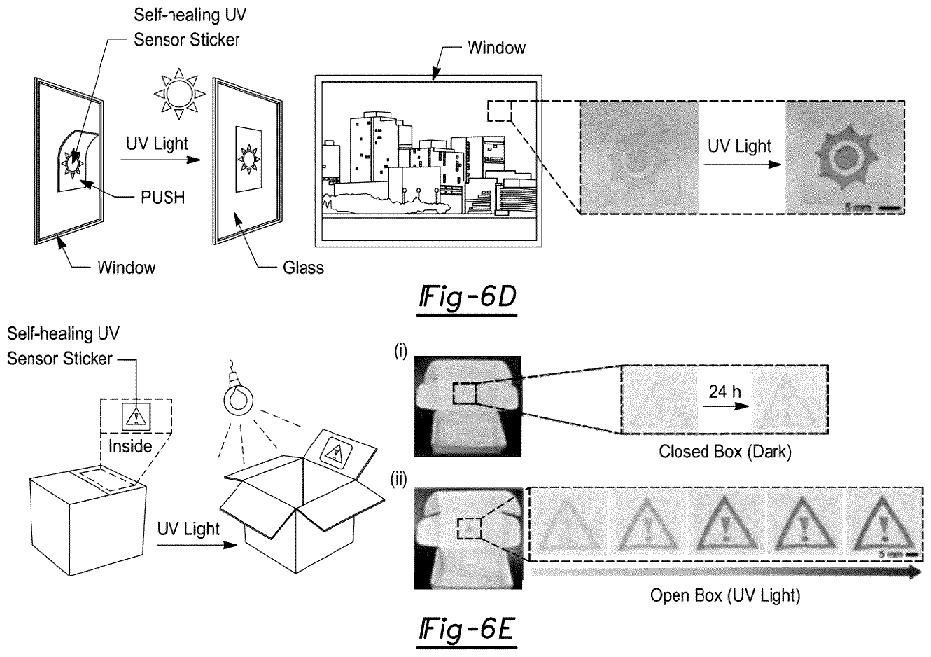

In this example, self-healing UV sensor stickers, UV detection patches, and UV detection wristbands are fabricated and evaluated. Pristine photoPUSH samples formed as described above in Example 1 having 5.7 wt. % PMA (and a thickness of approximately 0.05 mm) were used as a UV sensor by cutting into sun-like and exclamation mark-like shapes using a cutter blade, which were then adhered to PUSH films (thickness approximately 0.3 mm) and healed at 70° C. in an oven for 5 hours to obtain self-healing UV sensor stickers, as shown in FIGS. 6D-6E. The UV sensor stickers with sun-like and exclamation mark-like shapes were attached to a glass window and a carboard box, respectively, which then were exposed to natural sunlight.

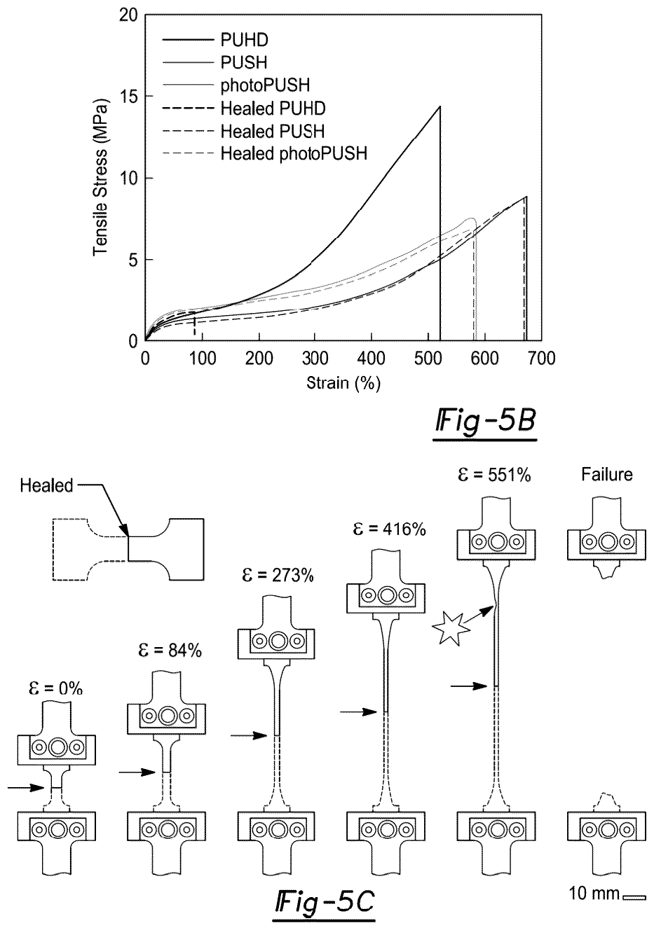

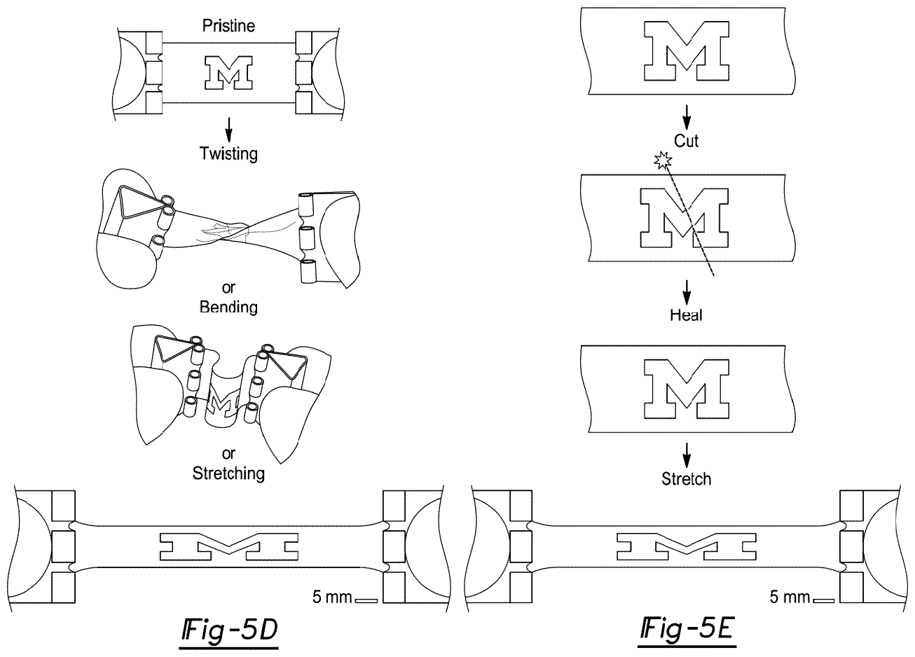

For UV detection patches and wristbands, photoPUSH with 1.1, 1.8, and 5.7 wt. % PMA (thickness approximately 0.05 mm) after being exposed to UVA light for 40 minutes were used as low, medium, and high reference colors of photoPUSH, respectively. A pristine photoPUSH with 5.7 wt. % PMA (thickness approximately 0.05 mm) was used as a UV detector. The reference photoPUSH samples were cut into a third of donut-like shapes while the UV detector was prepared as a circular film. The prepared photoPUSH films were assembled by placing the circular UV detector at the center among the reference photoPUSH, followed by attaching to a PUSH film and healing at 70° C. in an oven for 5 hours to obtain UV detection patches (FIG. 5a). The UV detection patch was attached to skin using a double-sided skin adhesive tape (MaskTite, USA). For attaching to cotton fabric, the UV detection patch was adhered to the fabric with a compression by being covered between glass substrates and compressed using binder clips (length of 32 mm), followed by heating at 80° C. in an oven for 24 hours.

A self-healing wristband was prepared for a human use by entwining a rectangular PUSH polymer sheet (length of about 16.5 cm, width of about 2.5 mm, and thickness of about 0.60 mm) around a glass cylinder, followed by healing at 70° C. in an oven for 24 h. The reference photoPUSH (diameter of about 6 mm), a rectangular UV detector (2.2 mm×9 mm), and a circular UV detector (diameter of about 5 mm) inside with an eight-angled star-like control photochromic film were attached to the wristband as the design shown in FIG. 5d, followed by healing at 70° C. in an oven for 5 hours.

Preparation of self-healing photochromic 1,3,3-trimethylindolino-6′-nitrobenzopyrylospiran (SP) SP/PUSH composites is as follows. A solution of SP/PUSH with concentration of 0.08 g mL⁻¹ was prepared by dissolving PUSH polymer in a solution of SP in DMAc (1 mM) at 25° C. The polymer solution (450 μL) was cast on a glass substrate (2.5 cm×2.5 cm×1.0 mm), followed by drying in the dark at 60° C. in a vacuum oven for 3 days to yield a self-healing photochromic composite film with 0.4 wt. % SP. The SP/PUSH composite film was irradiated with UVA light (365 nm, 25 W m⁻²) for 3 minutes to activate the color change. The reversibility of photochromism for SP/PUSH composite film is obtained upon heating at 60° C. in an oven for 3 minutes.

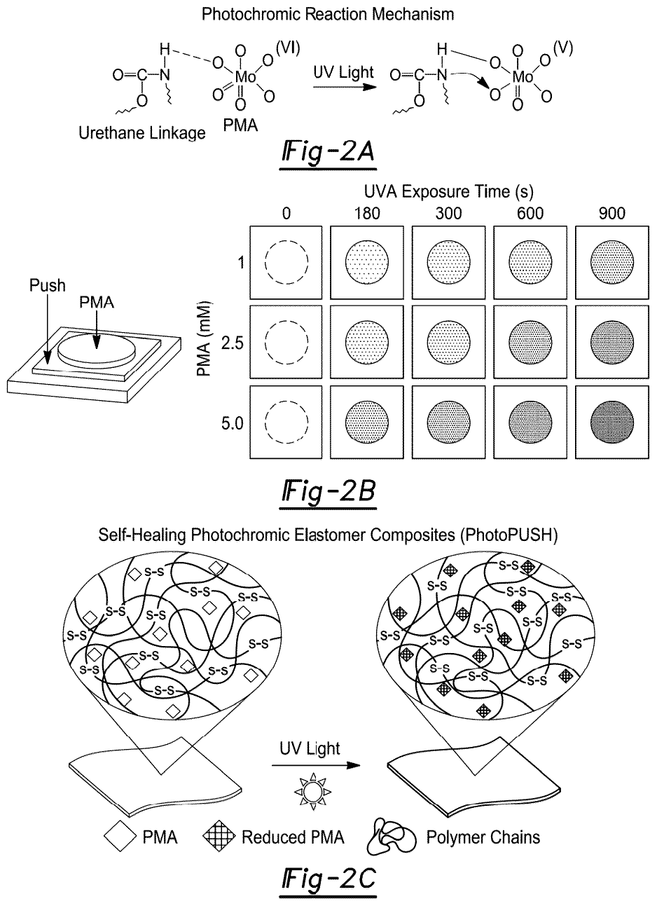

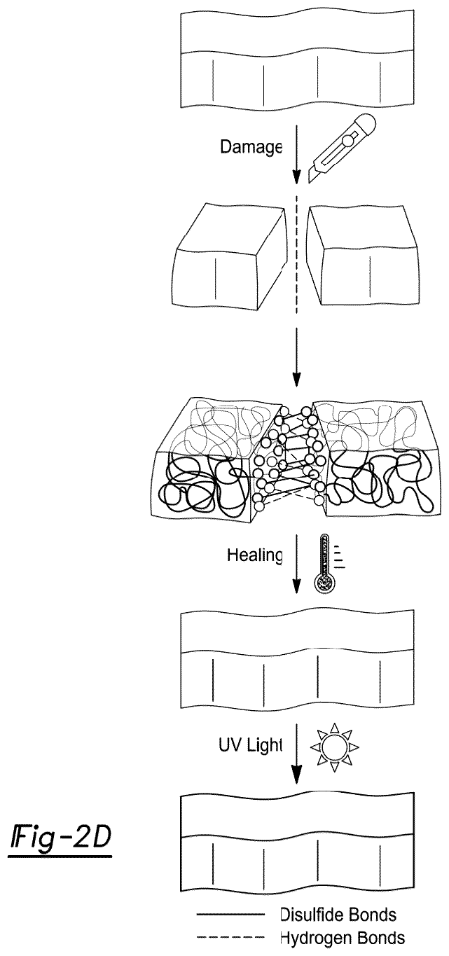

Phosphomolybdic acid (PMA) was incorporated as a UV-sensing nanofiller in a composite having the self-healing elastomer having electron donating functional groups which takes by taking advantage of its photochromic properties and resulting color change upon exposure to UV light. As discussed above, the color change of PMA can be activated with electron donating groups, such as disulfide, amine, and alcohol groups, in molecular structures of complementary polymers under UV light exposure. Consequently, molybdenum (Mo) metals in the Keggin structure of PMA were reduced from Mo⁶⁺ to Mo⁵⁺ as shown in FIG. 2A and converted into heteropolyblues via multi-electron transfer reactions in a photochemical reduction process.

In accordance with certain aspects of the present disclosure, PMA is incorporated into a functionalized self-healing polyurethane matrix (PUSH), which was synthesized by addition polymerization of polytetrahydrofuran (PTHF), dicyclohexylmethane 4,4′-diisocyanate (HMDI) and 2-hydroxyethyl disulfide (HEDS) (FIG. 2A). The photochromic reaction between PMA and PUSH with increasing UV exposure was monitored by FTIR spectroscopy. FTIR spectra displayed characteristic bands of PMA at 1060, 963, 881, and 777 cm⁻¹ for P—Oₐ stretching, Mo═O_{d} stretching, Mo—O_{b}—Mo stretching, and Mo—O_{c}—Mo stretching, respectively and characteristic bands of PUSH at 1229-1247 and 1110 cm⁻¹ for C—N stretching and C—O—C stretching, respectively. In photoPUSH films prepared in accordance with certain aspects of the present disclosure, the characteristic bands of PMA were shifted to 1065, 960, 880, and 812 cm⁻¹for P—Oₐ stretching, Mo═O_{d} stretching, Mo—O_{b}—Mo stretching, and Mo—O_{c}—Mo stretching, respectively, signaling the intermolecular forces between Keggin structures of PMA and the PUSH polymer matrix (FIG. 2A). Upon UVA light irradiation, the characteristic bands of PMA in the photoPUSH showed a red shift and their intensity decreased owing to the reduction of PMA after accepting protons from the PUSH matrix to form heteropolyblues. The decreased intensity of the FTIR bands associated to heteropolyblues agrees with other reports of the same photochromic mechanism in the literature (with hydroxyl and amino groups as donors). However, while previous reports of PMA-photochromic sensor materials rely on PMA/polymer systems or ink solutions with electron donor additives that are deposited on rigid and non-stretchable substrates, photoPUSH composites prepared in accordance with certain aspects of the present disclosure do not require additives (e.g., dopants or catalysts), but rather incorporate electron donor groups directly into the polyurethane elastomer structure, resulting in a stretchable, monolithic, photochromic material. In this approach, PUSH polymers prepared in accordance with certain aspects of the present disclosure provide structural and photochromic functions simultaneously, thus eliminating the need for organic electron donor additives or rigid substrates that were required in previous approaches.

To highlight the important role of the polymer matrix in the photochromic mechanism and to evaluate the synergistic properties of the PUSH materials developed here, different common substrates and flexible polymer materials were benchmarked by depositing a layer of PMA and observing the color change with UV exposure. While most substrates did not exhibit any color change due to the lack of electron donor groups, PMA deposited on PUSH prepared in accordance with certain aspects of the present disclosure and PUHD (control polyurethane elastomer without disulfide bonds) substrates exhibited a sharp shift from colorless to blue (FIG. 2B), which became more intense with an increasing amount of PMA and increasing exposure time. These results indicated that PUSH polymers can act as an electron donor active matrix (due to its urethane groups) (FIG. 2C), thus eliminating the need for additives and external electron donors typically required in other UV-sensing formulations (such as citric acid or lactic acid). Therefore, in addition to their mechanical, healing, and adhesive properties, the PUSH polymers prepared in accordance with certain aspects of the present disclosure directly enable the photochromic properties in PMA composites, therefore performing multiple functions simultaneously in this materials system (FIG. 2D showing self-healing and UV sensing abilities).

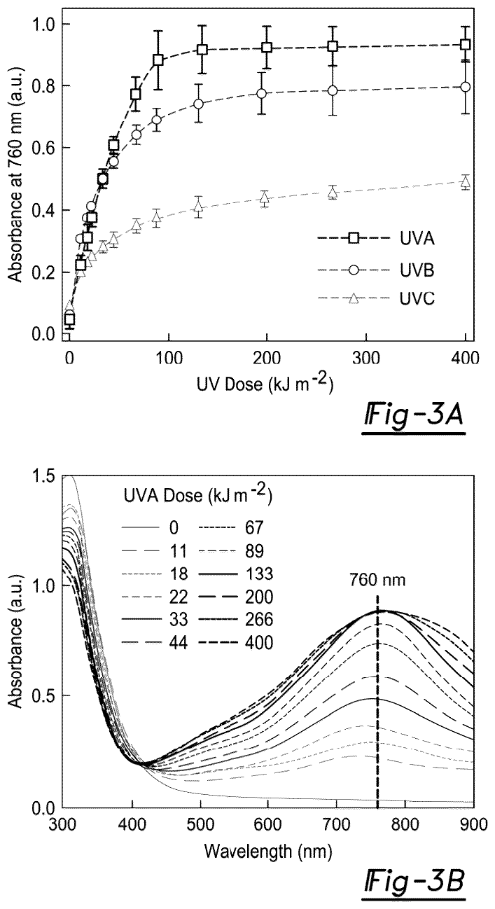

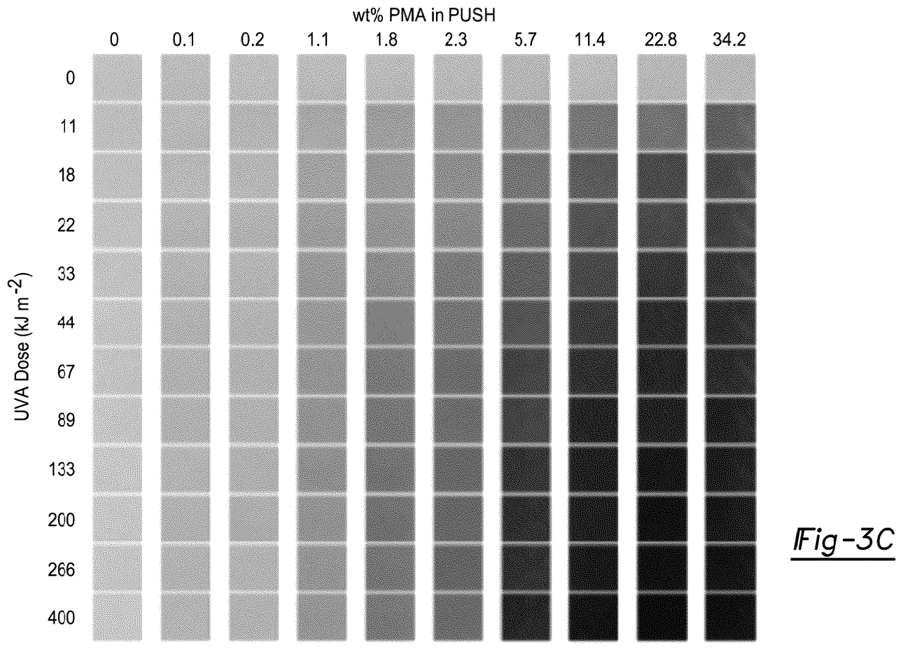

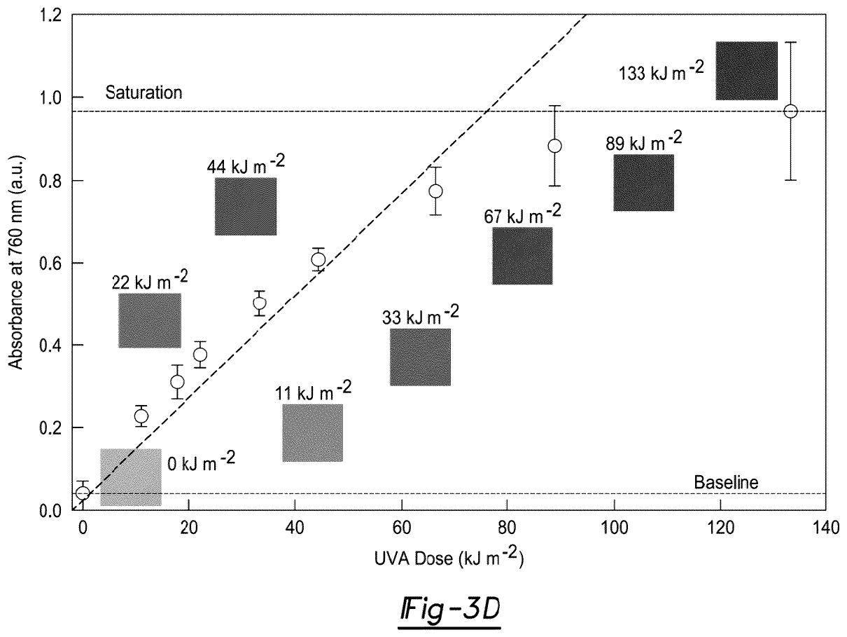

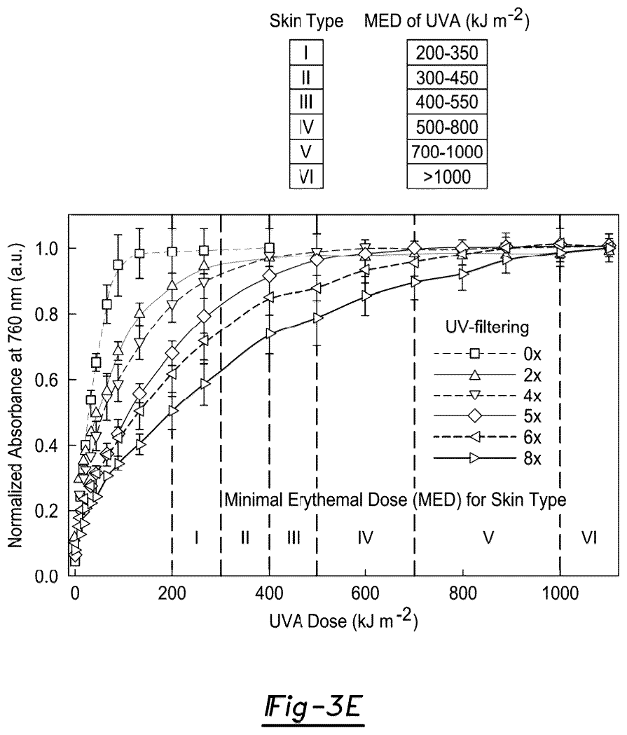

In order to characterize the response to UV light, the color change of photoPUSH films was measured upon exposure to UVA (λmax=368 nm), UVB (λmax=306 nm), and UVC (λmax=265 nm) radiation. As shown in FIG. 3A, the absorption intensity at a wavelength of 760 nm of photoPUSH films increased with UVA, B, and C doses until it reaches a plateau. The increase of absorption intensity at a wavelength of around 760 nm reflects the visible color change of photoPUSH with UV irradiation (FIG. 3B), which corresponds to the reduction of Mo⁶⁺ to Mo⁵⁺ in the Keggin structure of PMA. PhotoPUSH films displayed the largest responsivity to UVA, followed by UVB, and UVC according to the highest absorbance at a plateau. This is largely caused by different absorption of UVA, B, and C light by the PUSH matrix, where UVC light is absorbed at the greatest amounts, as where UVA light is the least absorbed/most transmitted. Therefore, photoPUSH variations prepared in accordance with certain aspects of the present disclosure exhibit spectral selectivity (differentiation of absorbance among UVA, B, and C) when exposed to the different UV light dose with more than 50 kJ m⁻². It is generally accepted that UVB has high risk of inducing skin cancer due to its involvement in the direct photochemical damage to DNA. However, UVA light was targeted for sensing here due to the fact that 95% of UV rays reaching the earth's surface are UVA rays. In addition, UVA rays penetrate deeper into the skin and are absorbed by endogenous photosensitizers in human skin to generate radicals or reactive oxygen species, which can damage DNA and increase the risk of melanoma and other types of skin cancer. Therefore, UVA is considered a better indicator of UV dose, which can in turn be used to calculate UVB and UVC. PhotoPUSH composites with different amounts of PMA were illuminated with different doses of UVA light (λmax=368 nm) and characterized FIG. 3C. After UVA irradiation, the color of photoPUSH films with 0.1 and 0.2 wt. % PMA did not significantly change and was similar to the control PUSH film. PhotoPUSH films with 1.1, 1.8, 2.3, and 5.7 wt. % PMA displayed a color change from colorless to blue, and the films with 11.4, 22.8, and 34.2 wt. % PMA turned from yellow to dark green and to dark blue with increasing UVA dose. The photochromic effect was measured in the 0 ° C. to 40° C. temperature range, without significant changes in color change with UVA dose or saturation color (indicating that this materials system is stable and not affected by temperature fluctuations within this range). In addition, the dark saturated colors are highly stable, and are preserved for at least 22 days without any exposure to UV light (dark conditions). However, if desired, the color change in the material can be reversed chemically by inducing the oxidation of the PMA molecules. FIG. 4 shows photographs showing the reversible color transition of a photoPUSH composite prepared in accordance with certain aspects of the present disclosure having 11.4 wt. % PMA upon oxidation with an aqueous solution of hydrogen peroxide, followed by drying. The composite is then exposed to UVA again for 30 minutes and shows reemergence of color. This reversible color change demonstrates the composite materials are capable of being used for UV-sensing over multiple cycles.

The absorbance at 760 nm was used to quantify the reduction of PMA at a certain dose of UVA light exposure and to quantitatively monitor the photochromic evolution with UVA light in the full range of PMA amounts in PUSH. The absorption saturation was reached when most of the PMA molecules were reduced to heteropolyblues, which varied with amount of PMA. A photoPUSH with 5.7 wt. % PMA was selected as the model formulation for photoPUSH photochromic composites due to its gradual change from colorless to blue with an initial linear increase of absorbance at 760 nm with UVA dose (FIG. 3D). The absorption intensity reached a plateau at a UVA dose of 130 kJ m⁻², resulting in a saturated blue color that remained constant upon further irradiation. This saturation dose delimitates the UV sensing range of the composites; however, UV radiation affects each skin type differently (melanin, present at different concentrations in different skin types, is a UV absorber that reduces the penetration of UV through epidermis). Therefore, to expand the sensing range of photoPUSH composites, the saturation threshold dose was increased by integrating melanin-mimicking thin polyethylene terephthalate (PET) film UV filters. As shown in FIG. 3E, the absorbance at 760 nm (e.g., color change) of photoPUSH composites with integrated filters increases more slowly with UVA dose, and the saturation threshold is delayed and extended to larger UVA doses (higher exposure). Therefore, with certain materials design, photoPUSH composites with integrated filtering can be used as film sensors to track UVA radiation with a visible color change within a tunable dose range and threshold that can be adjusted to different skin types. The capacity of each skin type to resist sunburn is determined by the lowest UV dose called minimal erythemal dose (MED). Hence, photoPUSH composite films with UV filtering of 0×, 2×, 4×, 5×, 6×, and 8× were fabricated for UVA detection of skin types I through VI, respectively as shown in FIG. 3E. The saturation threshold of each sensor was adjusted to match the MED for different skin types, so the sensor saturates in a dark blue color when entering a specific MED (potentially hazardous dose) and alerts the user to avoid further exposure.

### EXAMPLE 3

In this example, mechanical and healing properties of photoPUSH composites prepared in accordance with certain aspects of the present disclosure are evaluated to evaluate photoPUSH composite elastomers as potential wearable sensors. More specifically, their stability and durability under mechanical stress were characterized. First, three different fabrication methods to incorporate PMA dopants into the self-healing materials are explored: (i) directly depositing PMA ink on a PUSH substrate (previously used in PMA photochromic devices), (ii) depositing a PMA ink layer and encapsulating it between two PUSH layers, and (iii) dispersing PMA in the bulk PUSH matrix (photoPUSH) to form a composite. Although PMA was homogeneously dispersed, (i) and (ii) showed cracking when stretched as shown in FIG. 5A. The ink-deposited PMA layer (i) showed cracking perpendicular to the strain throughout all the deposited area. The encapsulated layer (ii) exhibited similar cracking, but only on the edges. However, PMA dispersed in the bulk (hereinafter referred to as photoPUSH) exhibits good mechanical stability and strong interfacial bonding between PMA and the PUSH matrix, and did not exhibit any visible signs of cracking, delamination, or any noticeable defect (under approximately 100% strain). The mechanical properties of photoPUSH (5.7 wt. % PMA) prepared in accordance with certain aspects of the present disclosure were further evaluated through tensile testing with dog-bone tensile specimens. The average tensile strength (σ) of pristine PUHD (control polyurethane lacking disulfide bonds), PUSH (control without PMA/photochromic agent), and photoPUSH prepared in accordance with certain aspects of the present disclosure was 14.6±1.2 , 8.1±0.8 , and 7.4±0.5 MPa respectively, while average ultimate strain (ε) of pristine PUHD, PUSH, and photoPUSH was 496±31, 613±55, and 544±41%, respectively as shown in FIG. 5B. The effect UV light on the creep of PUSH elastomers under shear with a constant stress of 0.1 MPa was also measured, without observing any significant difference in creep behavior.

To investigate the healing ability of the composites prepared in accordance with certain aspects of the present disclosure, dog-bone tensile specimens were cut into two pieces and joined together at the cut, followed by healing at 70° C. for 24 hours. σ and ε of healed PUHD were 1.9±0.2 and 92±15%, which were much lower than pristine PUHD, whereas the σ and ε of healed PUSH and healed photoPUSH were identical to those pristine samples. As a result, healing efficiency (the ratio of tensile strength of healed samples to pristine samples) of PUHD, PUSH, and photoPUSH was 13%, 99% and 97%, respectively. These results indicated that PMA dispersed in PUSH did not affect significantly the self-healing properties. In addition, a healed specimen from PUSH and photoPUSH was stretched until failure, which occurred at a pristine location (FIG. 5C), suggesting that the healing efficiency of the photoPUSH was comparable to bare PUSH polymer.

The photoPUSH prepared in accordance with certain aspects of the present disclosure also exhibits good stability and durability under different types of mechanical stress, including twisting, bending, and stretching (FIG. 5D) without any visible damage or delamination, as well as excellent healability after extreme damages such as cutting and scratching of the films (FIG. 5E). These results suggest that both undoped and PMA-doped PUSH elastomers can be joined together and healed with good interfacial strength, thus enabling the integration of photoPUSH in multimaterial device designs.

### EXAMPLE 4

In this example, PhotoPUSH composites prepared in accordance with certain aspects of the present disclosure are formed into UV-sensor stickers and evaluated. After understanding and characterizing the photochromic, mechanical, and healing properties, photoPUSH-based UV-sensors that could be portable and easily implemented on a variety of surfaces were formed. Hence, PUSH sensor stickers were fabricated that adhere to a variety of surfaces taking advantage of the polymer network viscoelasticity. First, the adhesive properties of PUSH films were characterized by measuring the pull-off forces in controlled contact measurements (preload, contact time, loading and retraction rates) on flat surfaces as shown in FIG. 6A. The measurements were performed at a minimum of 3 repetitions (adhesion-detachment cycles) per sample and per substrate to confirm that the adhesion is reversible and that the surfaces are not damage in the process and the adhesion is progressively lost (FIG. 6B). The adhesion of PUSH polymer films is measured in a variety of common household substrates (FIG. 6C), including polystyrene (63±2 kPa), glass (58±3 kPa), polyethylene (55±1 kPa), PET (35±0.3 kPa), stainless steel (31±0.5 kPa), PUSH (22±1 kPa), paper (22±1 kPa), PDMS (8±0.1 kPa), sandpaper (5±0.1 kPa), and cotton fabric (1±0.1 kPa). These measurements were all performed at room temperature and low preloads (2N) to simulate gentle pressure (equivalent to a 0.2 kg force approximately) to adhere to the substrates easily. It was observed that the adhesion to rough surfaces was low (e.g., sandpaper, paper, or cotton); however, this can be further improved with higher preloads and higher temperature to increase surface contact.

To take advantage of the adhesion of PUSH to these different substrates and of the good healing interfacial bonding strength between PUSH films, UV-sensor stickers were fabricated from (a) a bottom PUSH film as an adhesive layer and (b) a top patterned photoPUSH film for photochromic display. For example, a photoPUSH UV-sensor sticker (with a photochromic “sun”) was attached to a glass window and changed from colorless to blue after being exposed to natural sunlight for 8 hours as shown in FIG. 6D. A photoPUSH UV-sensor sticker (with a photochromic warning sign) was attached to the inside of a cardboard storage box in FIG. 6E. The colorless appearance of the photoPUSH sticker was stable in the dark (box closed) for over 24 hours. When the box was opened and its interior were exposed to ambient light, the sticker gradually shifted to blue color. These experiments demonstrate the potential of photoPUSH adhesive composites as UV-sensing stickers in various applications, such as monitoring light in photosensitive workspace environments (e.g., cleanrooms and chemical synthesis spaces) or as packaging indicators for shipment, storage, and anti-tampering indicators of photosensitive materials.

### EXAMPLE 5

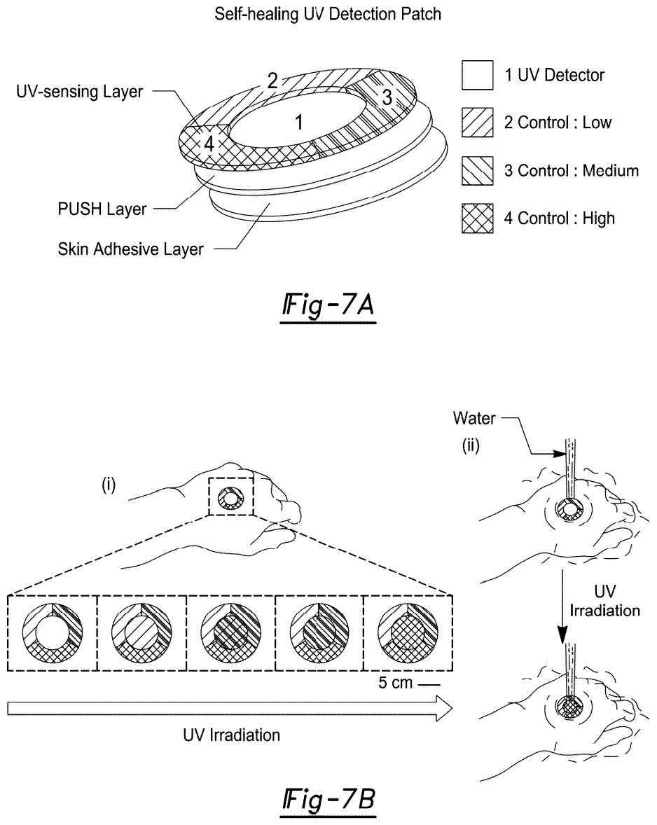

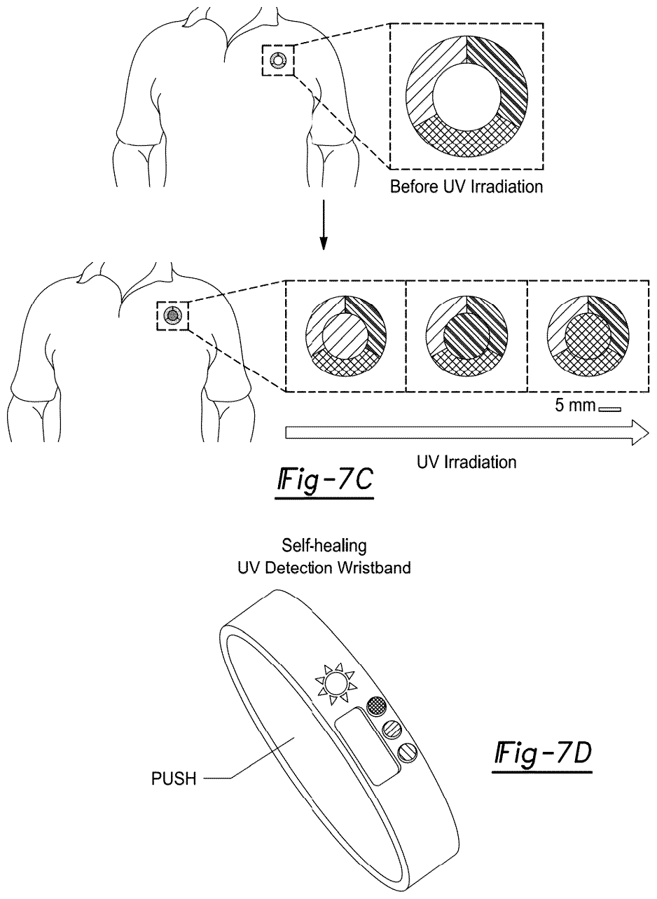

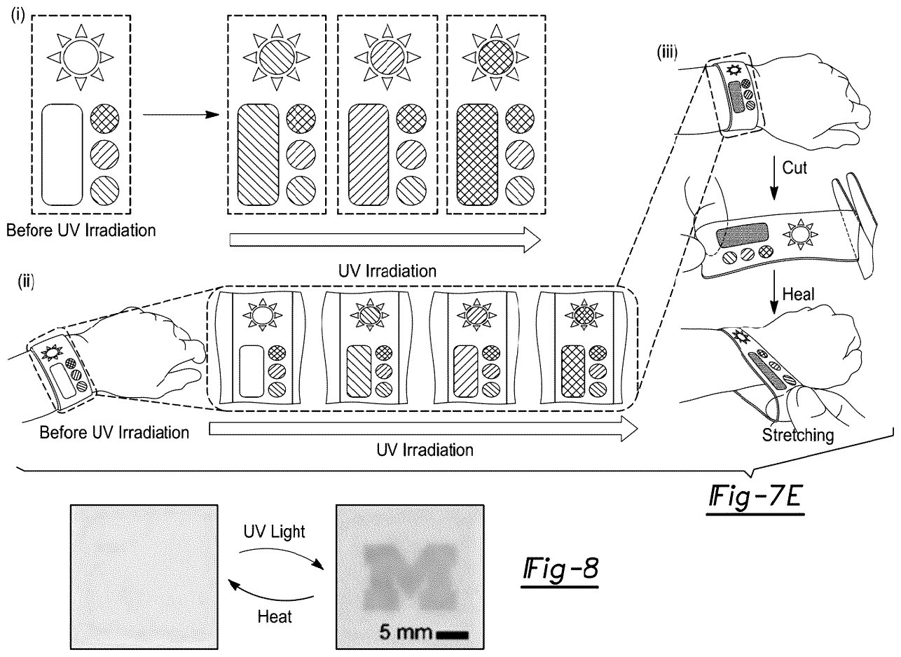

In this example, PhotoPUSH composites prepared in accordance with certain aspects of the present disclosure are used to form UV-sensing wearable devices. Taking advantage of their elastomeric, healing, and adhesive properties, PUSH-based photochromic composites prepared in accordance with certain aspects of the present disclosure can be also applied in wearable sensing technology, where continuous use under extreme mechanical stresses and dynamic environments can lead to loss of function and sensing performance. Here, photoPUSH composites with tuned compositions were integrated in UV detection patches, which were then mounted on human skin and textiles, as well as in UV detection wristbands. The UV detection patches were fabricated from three layers: (bottom) an adhesive layer for promoting adhesion to skin, (middle) a PUSH layer as a binder to provide bonding strength between all PUSH components, and (top) a UV-sensing layer with a UV detector and colorimetric references as shown in FIG. 7A. The UV-sensing layer was composed of three control photoPUSH films with 1.1, 1.8, and 5.7 wt. % PMA (low, medium, and high intensities). The UV-sensing layer was composed of three control photoPUSH films with 1.1, 1.8, and 5.7 wt. % PMA (low, medium, and high intensities). The UV detector includes a photoPUSH film with 5.7 wt. % PMA (matching the high intensity control film), not previously exposed to UV and therefore responsive to light, which will be used to monitor UV exposure. Once assembled, all the components were healed and bonded together yielding a monolithic multimaterial composite film. As shown in FIG. 7B, the color of the UV detection patch mounted on skin gradually evolves towards a dark blue upon cumulative UV irradiation, which can be progressively tracked by comparison with the reference saturated exterior bands. Due to the good stability and integration of all the PUSH composite elements (good dispersion and protection of the PMA, as well as good interlayer bonding strength), the sensing device is waterproof, and no loss in performance or function is observed after exposure to water before, during, and after sensing.

In addition to skin, the UV detection patch can also be mounted on textiles. A top UV-sensing layer and a PUSH adhesive layer were successfully mounted on cotton textiles by attaching the PUSH layer to cotton fabric and heating at 80° C., allowing the penetration of softened PUSH into the cotton fibers. Similar to skin-mounted sensors, the color of the UV detector on cotton fabric turned to dark blue upon UV irradiation (FIG. 7C), with the color change progressively monitored when compared to the reference bands.

An all-PUSH wearable wristband was fabricated with integrated UV detection patches as depicted in FIG. 7D. As shown, the wristband has a first detection indicia provided in a sun design sensor. The rays of the sun are control regions (have already been exposed to predetermined amounts of UV radiation), while the central circle of the sun is a detection region for sensing exposure of the wristband to UV radiation. The darkened control regions can provide a visible control for the wearer for comparing with the detection region of the center of the sun. When the central detection region changes color and is similar in darkness to the rays, the wristband has been exposed to a predetermined amount of UV radiation.

The wristband in FIG. 6D also has a second integrated UV detection patch with a different design. The detection region for real-time sensing of UV exposure is a rectangular shape. There are also three (shown by way of example) control regions in the form of circles disposed adjacent to one side of the rectangular shape. Each of the three circles has been exposed to distinct predetermined amounts of UV radiation, thus providing an ability to compare the detection region to different levels of UV radiation exposure.

The wristband was fabricated from PUSH films, the reference regions/bands from pre-exposed saturated photoPUSH films, and the detection patch from responsive photoPUSH, using the same architecture and designs as the previous devices described above. The shade of blue color of the UV detector increased with increasing UV irradiation, progressively matching the colorimetric reference levels (FIG. 7E(i)-7E(ii)). By comparing the wristband on a well-lit white background to a realistic application scenario (worn on the wrist, skin-mounted, or textile-mounted), the shades of blue colors are affected by the background. However, the color change due to background is consistent in all photoPUSH materials including the saturated reference regions/bands, and therefore the evolution of the sensor can still be tracked without any issues. If it is desired to remove the background effect, the versatile design of the device allows for additional components, and for example a white (or other colors) layer can be integrated as a bottom background layer.

Furthermore, because the wristband is built from all-PUSH materials, it is stretchable and can be healed from extreme mechanical damage that would otherwise terminate the device function, including scratches, severe large deformation, tear, and cuts. As shown in FIG. 7E(iii), the self-healing UV detection wristband was cut and subsequently healed at 70° C., enabling repair of the wristband and recovery of stretchability without loss of sensing function. Notably in most practical applications, it is anticipated that the sensor would withstand minor damage, such as scratches, delamination, or small cracks instead of deliberate extreme cuts, and therefore healing at lower temperatures would be possible.

In addition, PUSH polymers provide waterproof protection of the PMA components, and therefore enabling healing and sensing in wet environments (which is not possible with many sensor substrates that rely on electronics and on water-sensitive substrates). Due to the versatility of PUSH polymers as a multifunctional platform for photochromic devices, this approach can also be extended to other photochromic active molecules for sensing (such as spiropyran shown in FIG. 8). The wearable sensing devices demonstrated here (skin-mounted, textile-mounted, and wristband) have been designed and fabricated aiming for skin type I and for a MED of 200 kJ m⁻² as described previously. However, these devices can easily be extended to other skin types by integrating UV filters to adjust the UV absorbance and detection threshold (therefore tuning the MED to match specific skin types). This will lead to wearable sensors that can be worn on the skin, on clothes, or as accessories, that can monitor the UV exposure in real-time and notify the user with a visual color cue when it reaches dangerous dose levels (MED). Because of the flexibility, stretchability, healing properties, and durability of PUSH polymers, these wearable materials and devices can be used for sensing in challenging environments where UV exposure is overabundant and historically present skin damage risks.

A composition for detecting ultraviolet (UV) radiation comprising a self-healing elastomeric polymer comprising an electron donor functional group and a photochromic component provide various advantages. Such a composition can be incorporated into various devices for detecting and/or sensing UV radiation. For example, self-healing photochromic elastomer-based composites (photoPUSH) provided in certain variations incorporate photochromic components, like phosphomolybdic acid (PMA), into a dynamic polyurethane polymer network with reversible disulfide bonds (PUSH). The composites may be formed by solution blending and casting processes. The composition is capable of detecting a wide spectrum of UV light, including UVA, UVB, and UVC (e.g., having example wavelengths of 368 nm, 365 nm, 306 nm, and 265 nm). The UV-sensors provided by the present disclosure provide spectral selectivity, including an ability to discern between UVA and UVB radiation. The inventive UV sensors may have a sensitivity to light intensity ranging from greater than or equal to about 2 to less than or equal to about 5.6mW/cm² , including in the MED range. Further, the UV sensors provide real-time monitoring of a cumulative dose of UV radiation. The UV sensors incorporating such compositions are reusable, for example, capable of being reset and reused after a first period of usage, such that previous exposure data does not affect the ongoing performance of the sensor. The UV sensors also provide naked eye detection capability, meaning the state where the sensor response is detectable directly by a human eye and thus offers the user the sensing results without external interfaces, can be customized for different skin types (e.g., by incorporation of UV filters), is stretchable, and has self-healing ability. The UV sensors provided by certain aspects of the present disclosure are self-powered and battery-free, activation-free, and can be applied with sunscreen. As noted above, the UV sensors are water-resistant and/or waterproof such that when exposed to water they continue to function and provide UV detection performance.

In certain variations, the photoPUSH polymers display a color transformation from colorless to blue upon UV irradiation via photochromic reactions between the PMA molecules and electron donor groups in polyurethane structure of the elastomeric matrix. PhotoPUSH elastomers display excellent durability and no loss of performance under large strain deformations, in underwater environments (waterproof), and under extreme mechanical stress and severe damage. It is believe that these properties are attributable at least in part to the multifunctional, dynamic polyurethane network, which concurrently provides: (i) electron donor functional groups to enable the photochromic mechanism, (ii) excellent elastomeric properties (large deformations), durability, and protection of the photochromic dopants, (iii) high-efficiency healing to recover the structural integrity of the materials and the device function, (iv) adhesive properties and (v) strong interfacial bonding to enable the fabrication of architected devices and their attachment to surfaces. Taking advantage of these unique properties, soft, portable UV-sensing devices are contemplated for applications in environmental monitoring, packaging, and wearables (including skin-mounted, textile-mounted, and wristband devices). These sensors change their color with UV irradiation and provide a visual cue to alert the user when a dose threshold has been reached. Due to the healing properties of the PUSH matrix, the fabrication approaches are very versatile and allow for the incorporation of multimaterial complex designs. For example, integrated multimaterial UV-filtering in the sensors can adapt their sensing range and their alert saturation threshold to the hazardous UV doses (MED) of different skin types, thus demonstrating the tunability of the sensors through materials design.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A composition for detecting ultraviolet (UV) radiation comprising:
a self-healing elastomeric polymer comprising an electron donor functional group; and
a photochromic component distributed in the self-healing elastomeric polymer configured to display a color change when exposed to ultraviolet radiation, wherein the electron donor functional group promotes a photochromic reaction of the photochromic component in the presence of the ultraviolet radiation.

2. The composition of claim 1, wherein the self-healing elastomeric polymer comprises a polyurethane and the electron donor functional group comprises a disulfide group.

3. The composition of claim 1, wherein the photochromic component is selected from the group consisting of: phosphomolybdic acid, 1,3,3-trimethylindolino-6′-nitrobenzopyrylospiran, and combinations thereof.

4. The composition of claim 1 that is substantially free of any added dopants or catalysts.

5. The composition of claim 1, wherein the photochromic component is present at greater than or equal to about 0.1 % by weight to less than or equal to about 40% by weight of the composition.

6. The composition of claim 1, wherein the self-healing elastomeric polymer is present at greater than or equal to about 60 % by weight to less than or equal to about 99.9% by weight of the composition.

7. The composition of claim 1, wherein the self-healing elastomeric polymer comprises a polyurethane and the electron donor functional group comprises a disulfide group and the photochromic component comprises phosphomolybdic acid, wherein photochromic reaction promotes reduction of molybdenum in the phosphomolybdic acid in the presence of the ultraviolet radiation.

8. The composition of claim 1, wherein the photochromic component is homogenously distributed in the self-healing elastomeric polymer and defines a composite material.

9. The composition of claim 1, wherein the color change is reversible so that the composition can be regenerated and reused to detect exposure to ultraviolet radiation at least two times.

10. The composition of claim 1, wherein the ultraviolet radiation is selected from the group consisting of: UVA, UVB, UVC, and combinations thereof, the color change reflects cumulative exposure to ultraviolet radiation, and the at least one detection region has a sensitivity to ultraviolet radiation at an intensity of greater than or equal to about 2 mW/cm² to less than or equal to about 5.6mW/cm².

11. A product for detecting ultraviolet (UV) radiation comprising:
at least one detection region configured to receive and display a color change after exposure to ultraviolet (UV) radiation, the detection region having a composite material comprising a self-healing elastomeric polymer matrix comprising an electron donor functional group and a photochromic component distributed in the polymer matrix, wherein the electron donor functional group promotes a photochromic reaction of the photochromic component in the presence of the ultraviolet radiation.

12. The product of claim 11 further comprising at least one reference region in proximity with the at least one detection region, wherein the at least one reference region also comprises the self-healing elastomeric polymer matrix comprising the electron donor functional group and the photochromic component, wherein the at least one reference region has a first color indicating exposure to a predetermined amount of ultraviolet radiation that can be compared to a second color of the at least one detection region for determining an exposure level of the at least one detection region to ultraviolet radiation.

13. The product of claim 12, wherein the at least one reference region comprises at least two reference regions, wherein a first reference region has a first amount of the photochromic component, a second reference region has a second amount of the photochromic component, wherein the first amount is greater than the second amount.

14. The product of claim 11, wherein the at least one detection region is a layer disposed in or on a layer of the self-healing elastomeric polymer matrix comprising an electron donor functional group where the photochromic component is absent.

15. The product of claim 11, wherein the at least one detection region is a layer disposed over a layer of adhesive.

16. The product of claim 15, wherein the product comprises a first layer with the at least one detection region, an intermediate layer comprising a first side adjacent to the first layer, the intermediate layer comprising the self-healing elastomeric polymer matrix comprising an electron donor functional group where the photochromic component is absent, and a third layer adjacent to a second side of the intermediate layer comprising the adhesive.

17. The product of claim 11, further comprising at least one layer of an ultraviolet radiation filter disposed over the at least one detection region.

18. The product of claim 11 that is wearable by a user and the at least one detection region is visible and configured to display the color change to the user.

19. The product of claim 11 selected from the group consisting of: a sticker, a wristband, a patch, and combinations thereof.

20. The product of claim 11 that is waterproof, free of any batteries, and wherein the color change is reversible so that the product can be reused when the at least one detection region is regenerated and capable of detecting exposure to ultraviolet radiation at least two times.

21. The product of claim 11, wherein the self-healing elastomeric polymer matrix comprises a polyurethane, the electron donor functional group comprises a disulfide group, and the photochromic component comprises phosphomolybdic acid, wherein photochromic reaction promotes reduction of molybdenum in the phosphomolybdic acid in the presence of the ultraviolet radiation.

22. The product of claim 11, wherein the ultraviolet radiation is selected from the group consisting of: UVA, UVB, UVC, and combinations thereof, the color change reflects cumulative exposure to ultraviolet radiation, and the at least one detection region has a sensitivity to ultraviolet radiation at an intensity of greater than or equal to about 2 mW/cm² to less than or equal to about 5.6mW/cm².

23. A method for detecting ultraviolet (UV) radiation, the method comprising:
disposing a product having at least one detection region in an environment where UV radiation may be present, wherein the detection region comprises a composite material comprising a self-healing elastomeric polymer matrix comprising an electron donor functional group and a photochromic component distributed in the polymer matrix, wherein the electron donor functional group promotes a photochromic reaction of the photochromic component in the presence of the ultraviolet radiation; and
detecting exposure to UV radiation after the at least one detection region of the product displays a color change.

24-31. (canceled)
